(19) United States
(12) Patent Application Publication
(10) Pub. No.: US 2012/0204182 A1
(43) Pub. Date: Aug. 9, 2012

(54) PROGRAM GENERATING APPARATUS AND PROGRAM GENERATING METHOD

(75) Inventor: Masahiro DOTEGUCHI, Kawasaki (JP)

(73) Assignee: FUJITSU LIMITED, Kawasaki (JP)

(21) Appl. No.: 13/368,883

(22) Filed: Feb. 8, 2012

Related U.S. Application Data
(63) Continuation of application No. PCT/JP2009/003900, filed on Aug. 14, 2009.

(51) Int. Cl. G06F 9/44

(52) U.S. Cl. 718/102

(57) ABSTRACT

A program generating apparatus includes a second program generating unit to generate a second program including a memory image that reproduces data used to execute a subsection by a first arithmetic unit, subsection information including initial value information at the start position of the subsection, a program controlling portion to store the memory image in a second storing unit used by a second arithmetic unit, to set the second arithmetic unit to the same state as the first arithmetic unit at the start position of the subsection, and to cause the second arithmetic unit to execute the subsection of a first program, a monitor program including a function needed to execute the first program, and a monitor program initializing portion to make settings for causing the monitor program to provide a service requested when the second arithmetic unit executes the first program.

### CROSS-REFERENCE TO RELATED APPLICATION

This application is a continuation application of International Application PCT/JP2009/003900 filed on Aug. 14, 2009 and designated the U.S., the entire contents of which are incorporated herein by reference.

### FIELD

The embodiments discussed herein are related to a program generating apparatus and a method for generating a program.

### BACKGROUND

Conventionally, a technique of evaluating an information processing device under development by causing the information processing device to execute a predetermined program is known. The program for evaluating an information processing device under development is called a test program.

To accurately evaluate an information processing device under development, a test program plays an important role.

In relation to the above described technique, a method of sequentially recording an execution state of a program when the program is executed by an existing information processing device, and of generating a test program by reproducing contents of a memory based on the recorded state is known. This method is based on a concept such that since a CPU (Central Processing Unit) executes a program located in a memory and reads and writes contents of the memory when executing the program, operations of the CPU may be traced if the contents of the memory can be reproduced.

Additionally, a technique of storing a device driver by partitioning it into an OS (Operating System)-independent portion and an OS-depending portion in order to make a peripheral device support a plurality of types of host devices, and of controlling the peripheral device with the use of a device driver used by a host device is known.

Furthermore, a test program support system for testing only a desired portion of a program to be tested without variable settings and verifications, which are needed to test the program, regardless of whether or not the program to be tested is edited is known.
[Patent Document 1] Japanese Laid-open Patent Publication No. 2003-015914
[Patent Document 2] Japanese Laid-open Patent Publication No. 2005-038297
[Patent Document 3] Japanese Laid-open Patent Publication No. 2007-193586

### SUMMARY

According to an aspect of the embodiment, a program generating apparatus includes the following units.

A first storing unit stores data. A first arithmetic unit executes a first program expanded in the first storing unit.

An execution history taking unit stores, as an execution history of a subsection, initial value information about a state of the first arithmetic unit at a start position of the subsection that is a partial section of the first program executed by the first arithmetic unit, when the first arithmetic unit executes the first program. Moreover, the execution history taking unit stores, as the execution history of the subsection, information about an instruction executed by the first arithmetic unit in the subsection and data referenced when the instruction is executed.

A memory image generating unit generates, based on the execution history, a memory image that reproduces data used to execute the subsection by the first arithmetic unit within the first program expanded in the first storing unit.

A subsection information generating unit generates subsection information including the initial value information at the start position of the subsection.

A second program generating unit generates a second program including the memory image, the subsection information, a program controlling unit, a monitor program, and a monitor program initializing unit.

The program controlling unit expands the memory image in a second storing unit used by a second arithmetic unit that executes an arbitrary program, and sets the second arithmetic unit to the same state as the first arithmetic unit at the start position of the subsection according to the subsection information. Then, the program controlling unit causes the second arithmetic unit to execute the subsection of the first program.

The monitor program provides a function needed to execute the first program in the subsection among functions of an operating system. The monitor program initializing unit makes settings for causing the monitor program to provide a service requested when the second arithmetic unit executes the first program after expanding the monitor program in the second storing unit.

The object and advantages of the embodiment will be realized and attained by means of the elements and combinations particularly pointed out in the claims.

It is to be understood that both the foregoing general description and the following detailed description are exemplary and explanatory and are not restrictive of the embodiment as claimed.

### BRIEF DESCRIPTION OF DRAWINGS

FIG. 1 is an explanatory view of a test program generating apparatus;

FIG. 2 is an explanatory view of an outline of a process for generating a test program;

FIG. 3 is an explanatory view of an outline of a process for generating a test program;

FIG. 4 is an explanatory view of an outline of a test program;

FIG. 5 is an explanatory view of an outline of a process for executing a test program;

FIG. 6 is an explanatory view of execution forms of a test program;

FIG. 7 is an explanatory view of a process for terminating the execution of a test program;

FIG. 8 is an explanatory view of a process for estimating a memory space;

FIG. 9 is an explanatory view of an estimate of an initial state of a subsection of a test program;

FIG. 10 is an explanatory view of a method for generating memory initial image estimate information if an end position of a preceding subsection is inaccurate;

FIG. 11 is a schematic illustrating a portion of the test program generating apparatus for generating a test program;

FIG. 12 is a flowchart illustrating an outline of the process for generating a test program;

FIG. 13 is an explanatory view of an outline of a process for taking an execution history;

FIG. 14 is an explanatory view of an example of execution histories;

FIGS. 15A and 15B are a flowchart illustrating a process for taking an execution history;

FIG. 16 is an explanatory view of an outline of another example of the process for taking an execution history;

FIGS. 17A and 17B are a flowchart illustrating a process of another example of the process for taking an execution history;

FIG. 18 is an explanatory view of a flow of the process for generating a test program;

FIG. 19 is a flowchart illustrating a process of step S1205;

FIGS. 20A and 20B are a flowchart illustrating a process of step S1209;

FIG. 21 is an explanatory view of an outline of an execution process when a test program is executed standalone;

FIG. 22 is a flowchart illustrating an outline when the test program is executed standalone;

FIG. 23 is a flowchart illustrating an execution process when the test program is executed standalone;

FIG. 24 is an explanatory view of an outline of the execution process when the test program is executed on an OS;

FIG. 25 is a flowchart illustrating an outline when the test program is executed on the OS;

FIG. 26 is a flowchart illustrating an execution process when the test program is executed on the OS;

FIG. 27 is a block diagram illustrating a configuration example of the test program generating apparatus; and

FIG. 28 is a schematic illustrating an outline of performance evaluation using the test program.

### DESCRIPTION OF EMBODIMENTS

There may be cases where an information processing device under development may not actually execute a program executable in an existing information processing device. For example, if a CPU under development is evaluated, the CPU is sometimes evaluated by causing an emulator based on a design of the CPU to execute a test program. In this case, an OS may not be made to run on the emulator due to a memory capacity restriction placed on the emulator, or the like. Therefore, the same program as that executed in an existing information processing device may not be executed in some cases.

As described above, it is sometimes difficult to evaluate performance by causing an existing information processing device and an information processing device under development to execute the same test program. In this case, a comparison may not be simply made between execution results obtained by causing the existing information processing device to execute the test program and those obtained by causing the information processing device under development to execute the test program. Accordingly, there are difficulties inaccurately evaluating the performance of an information processing device under development, such as the performance of a CPU under development.

Additionally, if an information processing device under development is evaluated by using the above described emulator, many constraints such as the need for a very large amount of time to emulate hardware, the need for a large-capacity memory, the need to emulate an I/O process, and the like are imposed.

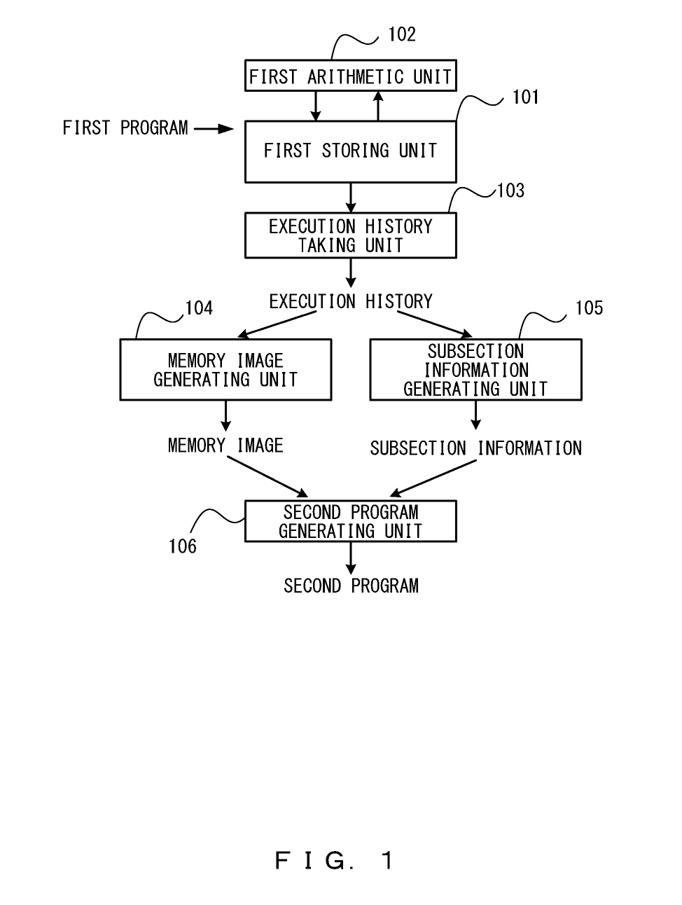

An embodiment is described below with reference to FIGS. 1 to 28. The embodiment described below is merely an example, and is not intended to preclude various modifications and technical applications, which are not explicitly described below. Namely, this embodiment may be diversely modified and carried out, for example, by combining embodiments within a scope that does not depart from the gist of the embodiment.

### An Embodiment

FIG. 1 is an explanatory view of a test program generating apparatus 100.

The program generating apparatus 100 includes a first storing unit 101, a first arithmetic unit 102, an execution history taking unit 103, a memory image generating unit 104, a subsection information generating unit 105 and a second program generating unit 106.

The first storing unit 101 is a storing unit configured to store data.

The first arithmetic unit 102 is an arithmetic unit configured to execute a first program expanded in the first storing unit 101. However, the first arithmetic unit 102 is not limited to the arithmetic unit configured to only execute the first program. Moreover, the first arithmetic unit 102 may be implemented with hardware or with a program such as an emulator for emulating an arithmetic device, as needed.

The execution history taking unit 103 obtains initial value information about a state of the first arithmetic unit 102 at a start position of a subsection that is a partial section of the first program executed by the first arithmetic unit 102, when the first arithmetic unit 102 executes the first program. The execution history taking unit 103 also obtains information about an instruction executed by the first arithmetic unit 102 in the subsection and about data referenced when the instruction is executed. The execution history taking unit 103 generates, as an execution history of the subsection, the initial value information, and the information about an instruction executed by the first arithmetic unit 102 in the subsection and about the data referenced when the instruction is executed.

The memory image generating unit 104 generates, based on the execution history, a memory image used to reproduce data that the first arithmetic unit 102 needs to execute the subsection within the first program expanded in the first storing unit 101.

The subsection information generating unit 105 generates subsection information including the initial value information at the start position of the subsection.

The second program generating unit 106 generates a second program including the memory image, the subsection information, a program controlling unit, a monitor program including a function that is needed to execute the first program in the subsection among functions of an OS, and a monitor program initializing unit.

The program controlling unit expands the memory image in a second storing unit used by a second arithmetic unit that executes an arbitrary program. The program controlling unit sets the second arithmetic unit to the same state as the first arithmetic unit 102 at the start position of the subsection according to the subsection information. Thereafter, the program controlling unit causes the second arithmetic unit to execute only the subsection of the first program.

Moreover, the monitor program initializing unit is a program of making settings for causing the monitor program to provide a service requested when the second arithmetic unit executes the first program after expanding the monitor program in the second storing unit.

With thus generated second program, the program controlling unit expands the memory image in the second storing unit, sets the second arithmetic unit to the same state as the first arithmetic unit 102 at the start position of the subsection, and causes the second arithmetic unit to execute only the subsection of the first program. Therefore, the second program may be executed on an OS.

Additionally, the second program makes settings for causing the monitor program to provide a service requested when the second arithmetic unit executes the first program after the monitor program initializing unit expands the monitor program in the second storing unit. Therefore, the second program may be executed in an environment without an OS.

By using the second program, the same process may be executed both in an environment where an OS does not run as in a CPU under development, and an environment where the OS is installed in an existing CPU. As a result, accuracy of performance evaluation of the CPU under development may be improved.

### Other Embodiments

### 1. Outlines of a Process for Generating a Test Program and a Process for Executing a Test Program

### 1.1. Outline of the Process for Generating a Test Program

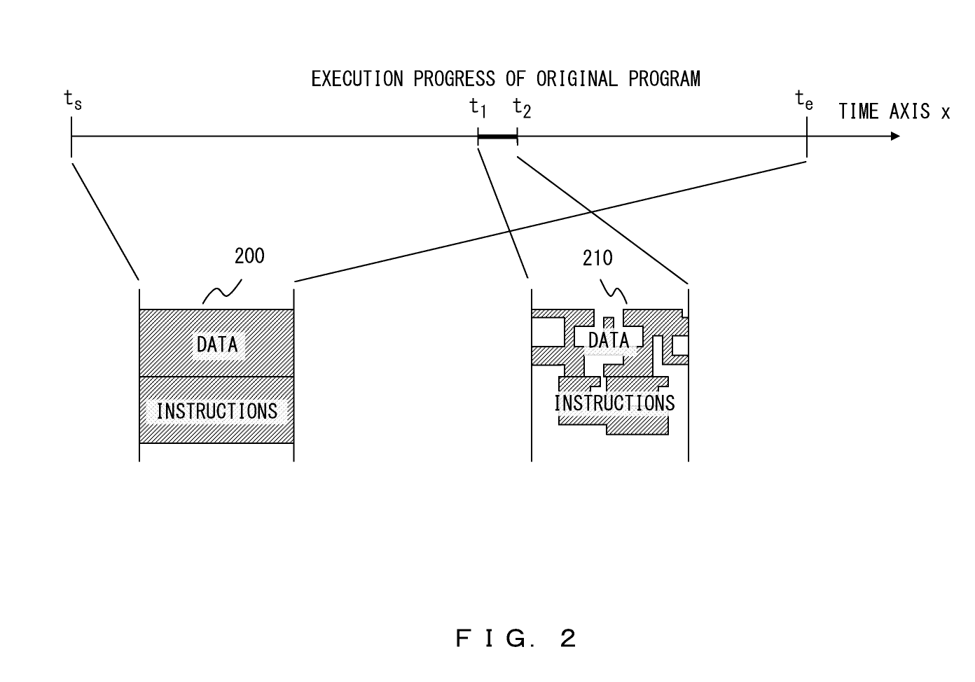

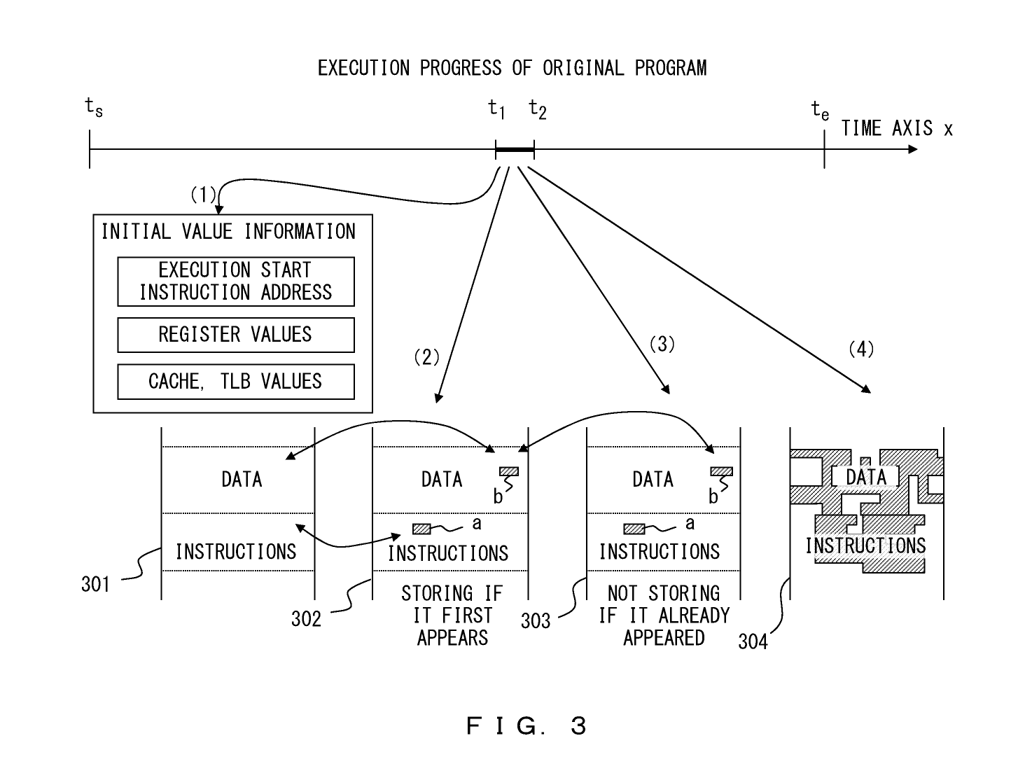

FIGS. 2 and 3 are explanatory views of the outline of the process for generating a test program.

A time axis x illustrated in FIG. 2 represents an execution progress of a predetermined program executed by an existing information processing device. The time axis x illustrated in FIG. 2 represents that the existing processing device starts to execute the predetermined program at a time ts and terminates the program at a time te.

The existing information processing device is, for example, an information processing device that has been already developed and is used to be compared with the performance of an information processing device under development. This information processing device may be also implemented with a program for emulating hardware. The program that is executed by the information processing device and is a base of a test program is called an original program.

When the whole of the original program is executed from beginning to end, data in an entire shaded portion represented in a memory space 200 is needed.

The memory space 200 represents an area which is an area of a memory included in the information processing device and in which the original program is expanded to be executable. The shaded portion within the memory space 200 represents an area where the original program is stored. The memory space 200 includes two major areas. One of the areas is a data area for storing data needed or temporarily used to execute a program instruction, and the like. The other area is an instruction area for storing program instructions and the like.

Here, when only a section from a time t1 to a time t2 of the original program is executed, only the data in the shaded portion represented within the memory space 210 is sufficient.

The memory space 210 is an area of the memory included in the information processing device, and represents data needed to execute the original program from the time t1 to the time t2.

A section where part of the original program is executed by the information processing device, for example, the section executed from the time t1 to the time t2 in FIG. 2 is hereinafter referred to as a subsection. Moreover, an instruction execution position at a subsection start time, for example, the time t1 illustrated in FIG. 2 is called a subsection start position, whereas an instruction execution position at a subsection end time, for example, the time t2 illustrated in FIG. 2 is referred to as a subsection end position.

In this embodiment, for example, an execution history of the original program in the subsection from the time t1 to the time t2 is taken. Then, a test program for causing the information processing device to execute the subsection from the time t1 to the time t2 by reproducing the memory space 210 is generated based on the taken execution history and the like.

A flow of the test program generation according to this embodiment is described with reference to FIG. 3.

When the execution process of the original program reaches the start time t1 of the subsection, the test program generating apparatus starts to take execution histories.

(1) Initially, the test program generating apparatus stores information about a state of the CPU at the subsection start position as history information. The information about the state of the CPU may include an execution start instruction address, values of all registers included in the CPU, contents of a cache and TLB (Translation Look aside Buffer), which are included in the CPU, and the like. The history information about the state of the CPU, which is taken at the subsection start position, is hereinafter referred to as initial value information.

The test program generating apparatus takes, as an execution history, referenced or changed data with respect to the memory space at the subsection start position.

It is advantageous to read and store the contents of the cache and the TLB if they may be read from the CPU. This is because the information of the cache and the TLB influence the performance evaluation of the CPU. However, if the contents of the cache and the TBL may not be read, information of memory access addresses before the subsection may be used as a replacement for the contents of the cache and the TLB.

(2) The test program generating apparatus monitors instructions executed and data referenced after the subsection start position, and the like. Upon detecting an instruction and data initially referenced after the subsection is entered, the test program generating apparatus stores the instruction and the data as an execution history. For example, upon detecting that an instruction a and data b, which do not exist in a memory space 301, are referenced, the test program generating apparatus stores the instruction a and the data b as history information.

(3) An instruction and data, which are once referenced after the subsection is entered, are not to be taken as an execution history. For example, upon detecting even the instruction a and the data b, which are represented in the memory space 302, the test program generating apparatus does not again store the instruction and the data as the history information. Similarly, upon detecting that data is updated, the test program generating apparatus does not store the data after being updated as an execution history.

(4) When the above described process is executed up to the subsection end position, a memory space 304 needed to execute the subsection is obtained. The test program generating apparatus according to this embodiment generates a test program based on the initial value information obtained at the subsection start position, the memory space 304 obtained from the subsection start position to the subsection end position, and the like.

This embodiment is not intended to preclude the entire section from the time is to the time to as a subsection. However, a test program is generated by only focusing a subsection as in this embodiment, whereby the amount of memory needed for the process for generating a test program may be reduced. Also a time needed to generate a test program may be shortened.

FIG. 3 is a schematic for explaining the outline of the process for generating a test program by taking, as an example, the case where the number of subsections is 1. The test program generating apparatus according to this embodiment, however, may set a plurality of subsections.

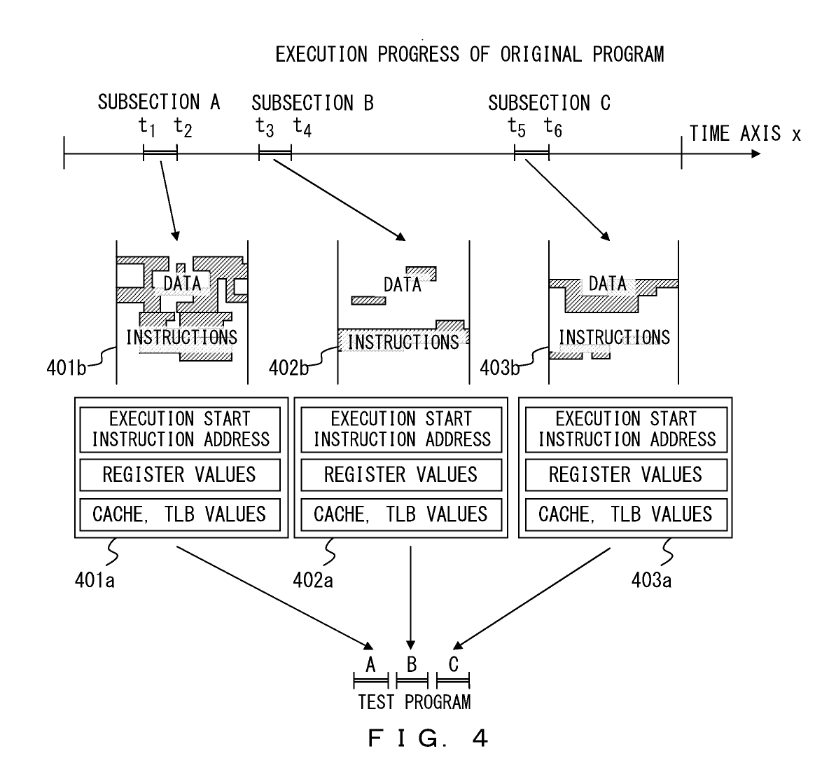

FIG. 4 is an explanatory view of an outline of a process for generating a test program based on a plurality of subsections.

A subsection A is a section from a start time t1 to an end time t2. A subsection B is a section from a start time t3 to an end time t4. A subsection C is a section from a start time t5 to an end time t6.

The test program generating apparatus obtains, from the subsection A, initial value information 401a at a subsection start position, and a memory space 401b when the original program is executed from the subsection start position to the subsection end position with the process described with reference to FIG. 3. The test program generating apparatus also obtains, from the subsection B, initial value information 402a at a subsection start position, and a memory space 402b from the subsection start position to a subsection end position. The test program generating apparatus further obtains, from the subsection C, initial value information 403a at a subsection start position, and a memory space 403b from the subsection start position to a subsection end position.

Then, the test program generating apparatus generates a test program for sequentially executing the subsections A, B and C based on the initial value information 401a and the memory space 401b, the initial value information 402a and the memory space 402b, and the initial value information 403a and the memory space 403b.

For example, one test program is generated by extracting a plurality of only subsections including a desired process such as a characteristic process and the like within an original program, whereby results of the processes in the plurality of subsections may be obtained at one time by once executing the test program. Accordingly, an information processing device under development may be efficiently evaluated.

When a test program generated based on a plurality of subsections is executed, memory spaces respectively at subsection start positions are needed. Information used to reproduce a memory space is hereinafter referred to as a memory image.

For example, when the test program illustrated in FIG. 4 is executed, the memory space 401b, the memory space 402b and the memory space 403b are needed to respectively execute the subsections A, B and C at their subsection start positions. Accordingly, three memory images are needed, leading to possible consumption of a large amount of memory.

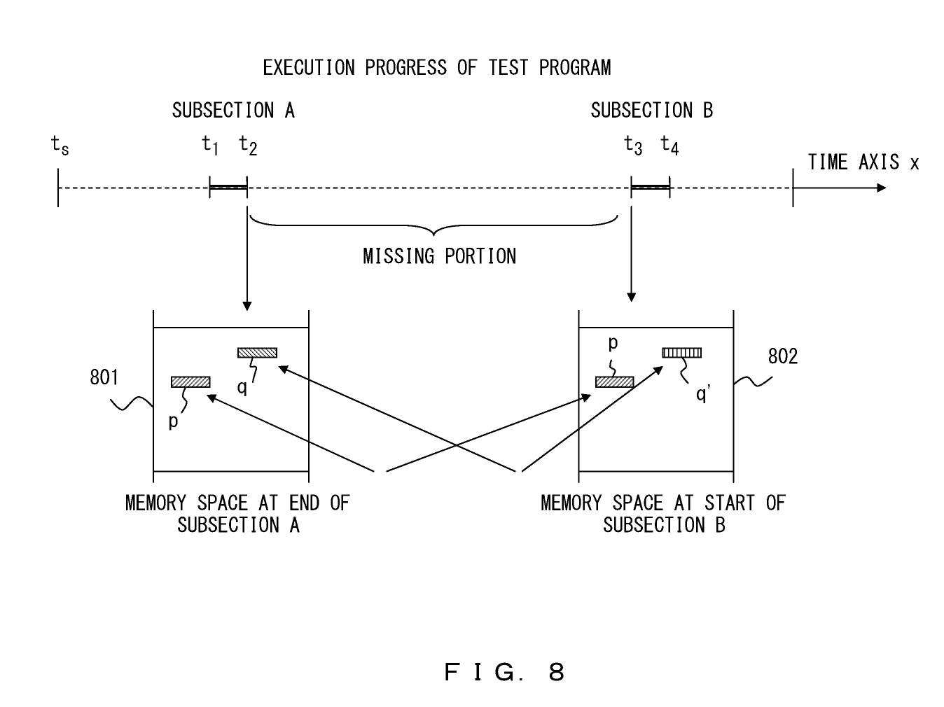

Therefore, in this embodiment, consumption of the amount of memory is reduced by estimating a memory space at each subsection start position as will be described later with reference to FIGS. 8 to 10.

### 1.2. Outline of the Process for Executing a Test Program

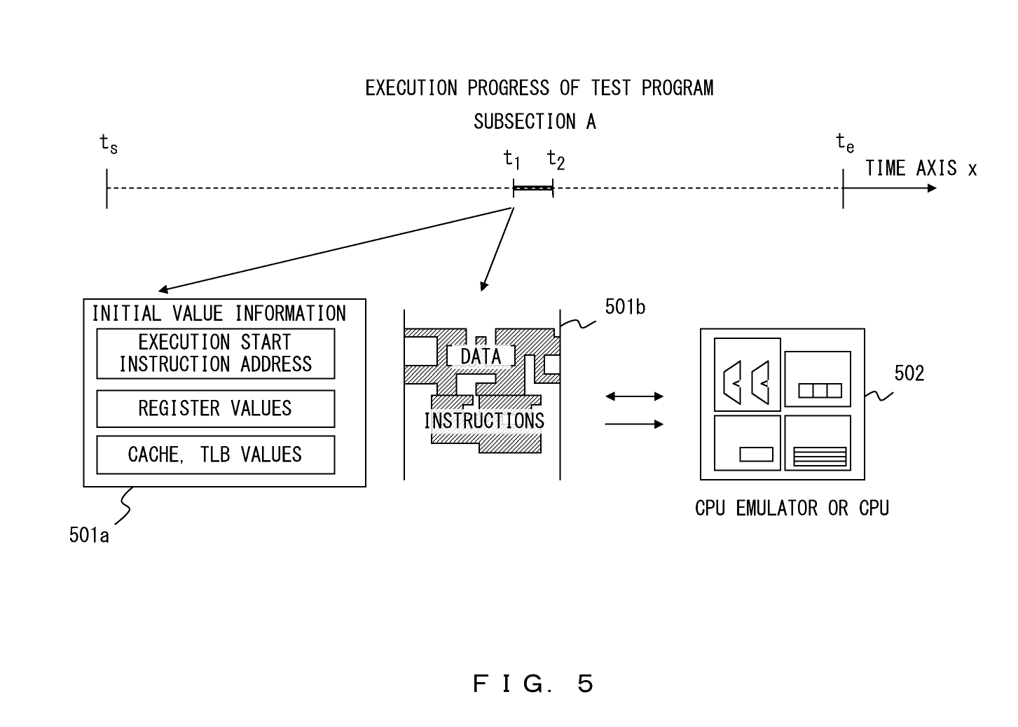

FIG. 5 is an explanatory view of the outline of the process for executing a test program. FIG. 5 represents a case where the test program for executing the subsection A is executed. A section from a time is to a time to represents an execution section of an original program.

As described above with reference to FIG. 3, the test program includes the initial value information 501a at the subsection start position, and the memory space 501b from the subsection start position to the subsection end position. When being executed, the test program reproduces the state of the CPU at the subsection start position according to the initial value information 501a. Moreover, the test program reproduces the memory space 501b based on an initial memory image 1801 to be described later.

Then, the test program causes a CPU or a CPU emulator 502 to execute the program at an instruction execution start address within the reproduced memory space 501b. Then, the CPU or the CPU emulator 502 sequentially executes instructions within the memory space 501b. Consequently, the CPU or the CPU emulator 502 executes only the subsection A of the original program. All of CPU emulators referred to in this embodiment are assumed to emulate not only a CPU but other hardware pieces needed to execute the program.

Note that the initial value information 501a does not always need to include the contents of the cache and the TLB. However, since the cache and the TL B are mechanisms for speeding up the execution process of the CPU, they may possibly influence the performance evaluation. Accordingly, it is desirable that the initial value information 501a includes the contents of the cache and the TLB.

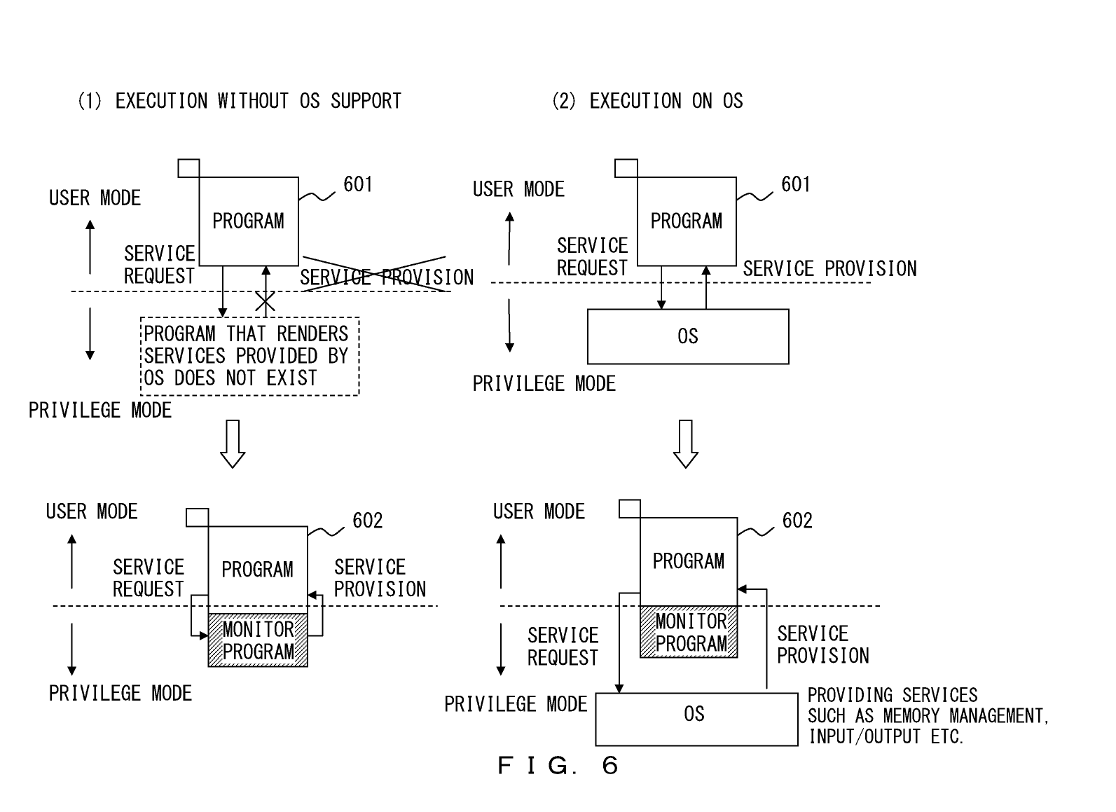

FIG. 6 is an explanatory view of execution forms of a test program.

The execution forms of the test program according to this embodiment include the following two forms. Each of the execution forms is dividedly illustrated as operations performed in a user mode for operating a program such as an application or the like, and as operations performed in a privilege mode for operating a program such as an OS or the like that provides services to an application or the like.

(1) The first execution form is that for executing the test program in a CPU emulator for emulating a CPU under development based on a design of the CPU, namely, in a state without a support of an OS.

The execution form for executing the test program in the state without the support of the OS is hereinafter referred to as standalone execution.

In this case, a program that provides services, such as memory management, input/output management and the like, rendered by the OS does not exist. Accordingly, a general program 601 that runs in the user mode may not receive the services to be provided by the OS.

However, since a test program 602 according to this embodiment includes a program that runs in the privilege mode, the program is executable even in an environment where the OS does not run. The program that is included in the test program 602 and runs in the privilege mode is referred to as a monitor program. The monitor program provides minimal services that are needed to execute the test program 602 and are to be provided by the OS or the like.

(2) The second execution form is that for executing the test program in an information processing device where an OS is installed, namely, on the OS.

In this case, also the test program 602 according to this embodiment may receive, from the OS, services needed to run as in the case where the program 601 receives, from the OS, services needed to run. Accordingly, the test program 602 runs by receiving the services needed to run not from the monitor program but from the OS. In this case, the monitor program is not used.

As described above, the test program 602 according to this embodiment may be executed in a state without the support of an OS and also on the OS. For example, the same test program 602 is made to run in an existing information processing device and a CPU emulator that runs according to a design of a CPU under development, whereby an identity of the processes may be evaluated.

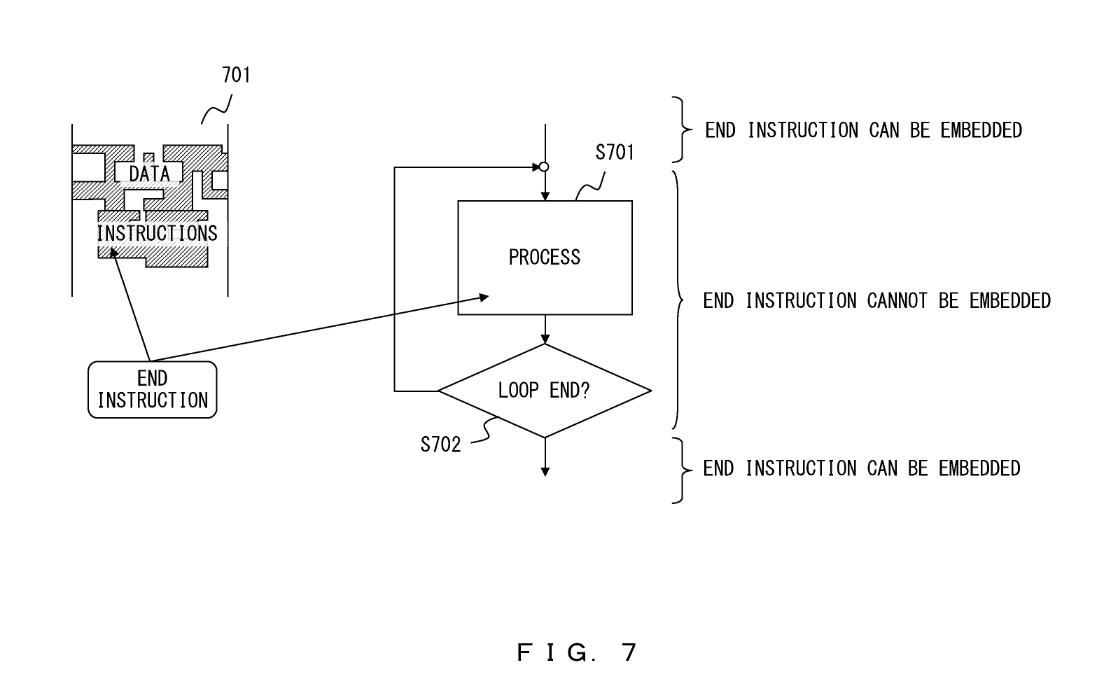

FIG. 7 is an explanatory view of a process for terminating the execution of a test program.

When the test program is terminated, an end instruction for terminating the program does not properly work in all cases even though it is embedded in the test program. For example, if the end instruction is embedded in an instruction address in a memory space 701 as in step S701 of a loop process illustrated in FIG. 7, the test program is terminated in step S701. In this case, the loop process straddling in steps S701 and S702 is not executed. Accordingly, the loop process straddling in step S701 and S702 may not be verified.

The end instruction can be embedded before or after the loop process as described above. However, if the loop process is included in a subsection, the end instruction cannot be embedded within the loop process. Accordingly, the test program according to this embodiment counts the number of executed instructions in a subsection, and terminates the execution of the test program in the subsection at the time point when the count value reaches a predetermined number of instructions. To count the number of executed instructions, an instruction count mechanism or the like included in a CPU may be also used.

In this embodiment, when a test program including a plurality of subsections is executed, a memory space at a start position of a second subsection next to a first subsection is estimated based on a memory space at an end position of the first subsection.

FIG. 8 is an explanatory view of a memory space estimate process.

Comparing a memory space 801 at an end position of a subsection A with a memory space 802 at a start position of a subsection B, data p is common in both of the spaces. Therefore, the data p is left unchanged from the memory space 801. In contrast, data q in the memory space 801 is changed to data q′. In this case, if the memory space 801 and information about the change of the data q to the data q′ exist, the memory space 802 may be estimated.

Accordingly, if there is difference information between the memory space 801 at the end position of the subsection A and the memory space 802 at the start position of the subsection B, the memory space 802 at the start position of the subsection B may be estimated based on the memory space 801 at the end position of the subsection A. This difference information is hereinafter referred to as memory initial image estimate information.

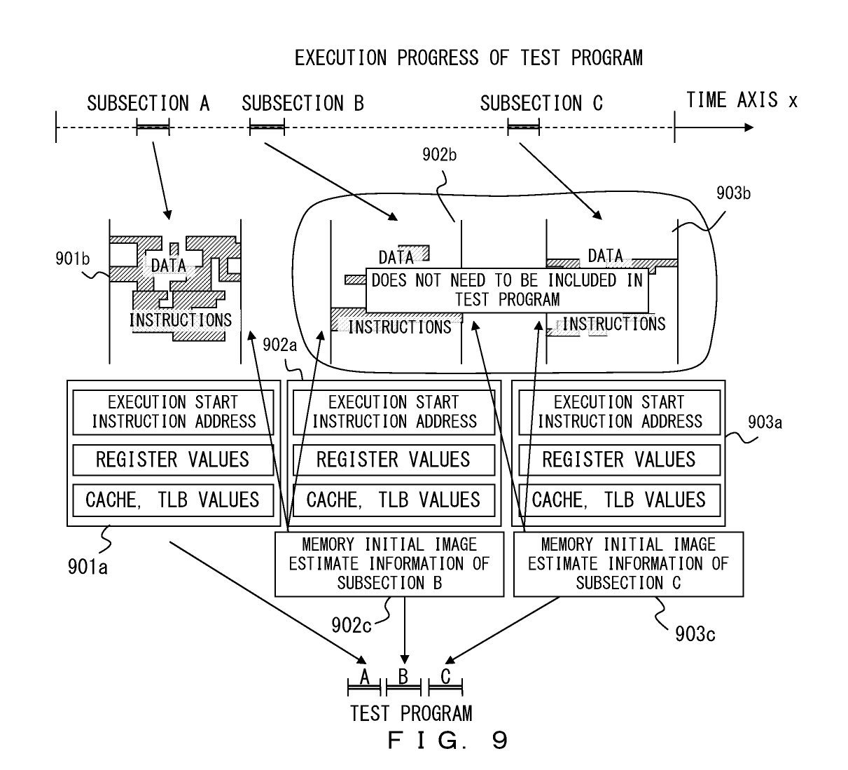

With the above described concept, a memory space 902b at a start position of a subsection B may be estimated by using memory initial image estimate information 902c of the subsection B based on a memory space at an end position of the first subsection A of a test program including a plurality of subsections A, B and C illustrated in FIG. 9. Similarly, a memory space 903b at a start position of the subsection C may be estimated by using memory initial image estimate information 903c of the subsection C based on a memory space at an end position of the subsection B.

Accordingly, the memory space 902b at the start position of the subsection B, and the memory space 903b at the start position of the subsection C may become unnecessary when the test program is executed, whereby the amount of used memory may be reduced.

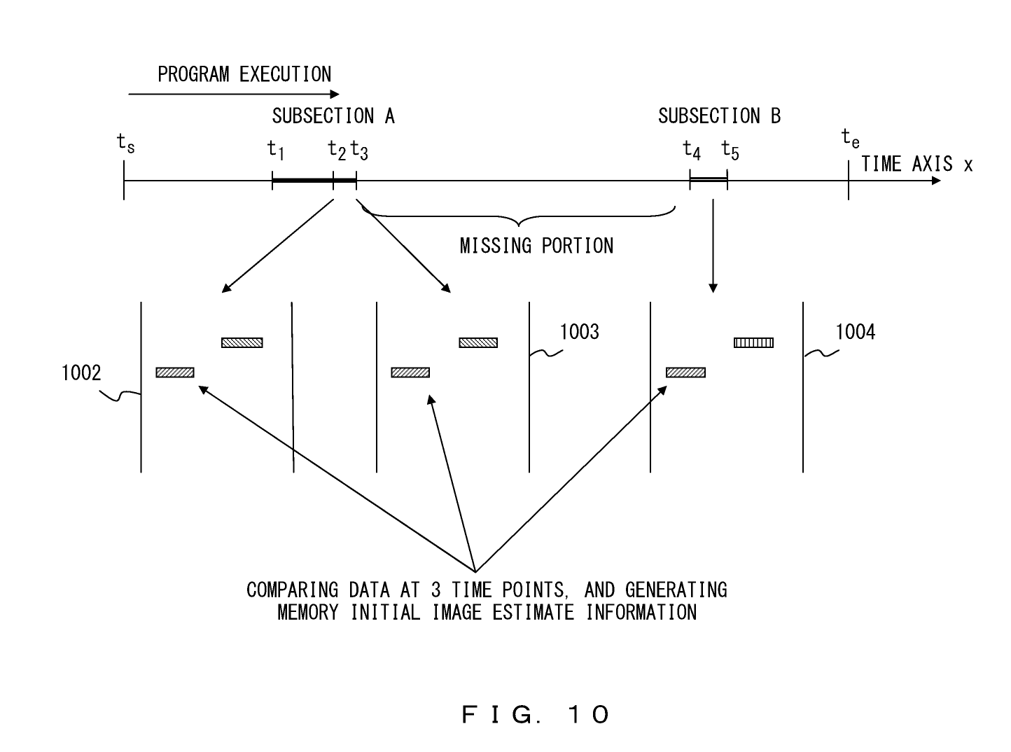

FIG. 10 is an explanatory view of a method for generating memory initial image estimate information if an end position of a preceding subsection is inaccurate.

A memory space 1002 is a memory space at a time t2 in a subsection A. Additionally, a memory space 1003 is a memory space at an end position of the subsection A, namely, at a time t3. Furthermore, a memory space 1004 is a memory space at a start position of the subsection B, namely, at a time t4.

For example, if the memory space 1004 at the start position of the subsection B is estimated by using the memory initial image estimate information of the subsection B based on the memory space 1003 at the end position of the subsection A, accuracy of the memory space 1003 at the end position of the subsection A is the point.

It is sometimes difficult to terminate the execution of a test program at a desired subsection end position. Accordingly, for example, the memory space 1003 at the end position of the subsection A when the memory initial image estimate information of the subsection B is generated, and a memory space 1003′ at the end position of the subsection A when the test program is executed do not match in some cases.

In this case, the memory initial image estimate information may be estimated as follows.

The test program generating apparatus stores the memory space 1002 at a time slightly earlier than the end time t3 of the subsection A, for example, at the time t2 earlier by several instructions. Upon detecting the initial memory reference of the subsection B, the test program generating apparatus compares contents of the memory space 1002 at the referenced address with those of the memory space 1004.

If the contents of the memory space 1002 at the referenced address and those of the memory space 1004 differ, the test program generating apparatus may estimate that the contents are changed in a missing portion between the subsection A and the subsection B.

Alternatively, if the contents of the memory space 1002 at the referenced address and those of the memory space 1004 match, the test program generating apparatus further compares the contents of the memory space 1003 at the referenced address and those of the memory space 1002.

If the contents of the memory space 1003 at the referenced address and those of the memory space 1002 differ, the test program generating apparatus may estimate that the contents is changed between the time t2 and the time t3 of the subsection A and is restored to an original value in a missing portion between the end time t3 of the subsection A and the start time t4 of the subsection B.

Alternatively, if the contents of the memory space 1003 at the referenced address and those of the memory space 1004 match, the test program generating apparatus may further estimate that the contents is left unchanged in the missing portion between the subsection A and the subsection B, or the contents is restored to an original value after being changed by a plurality of times in the missing portion.

As described above, the data at the three time points such as the time t2 and the time t3 of the subsection A, and the time t4 of the subsection B are compared, whereby an initial memory space in a subsection may be accurately estimated even if the end position of a preceding subsection is inaccurate. In each of the subsections, the end position of the original program, which corresponds to the time t2, and the end position of the original program, which corresponds to the time t3, are hereinafter referred to as a first end position and a second end position, respectively.

Accordingly, the test program generating apparatus may store, as memory initial image estimate information, results of the comparison made between the contents of the memory space 1002 and those of the memory space 1004, and results of the comparison made between the contents of the memory space 1003 and those of 1004.

### 2. Details of the Process for Generating a Test Program and the Process for Executing a Test Program

### 2.1. Process for Generating a Test Program

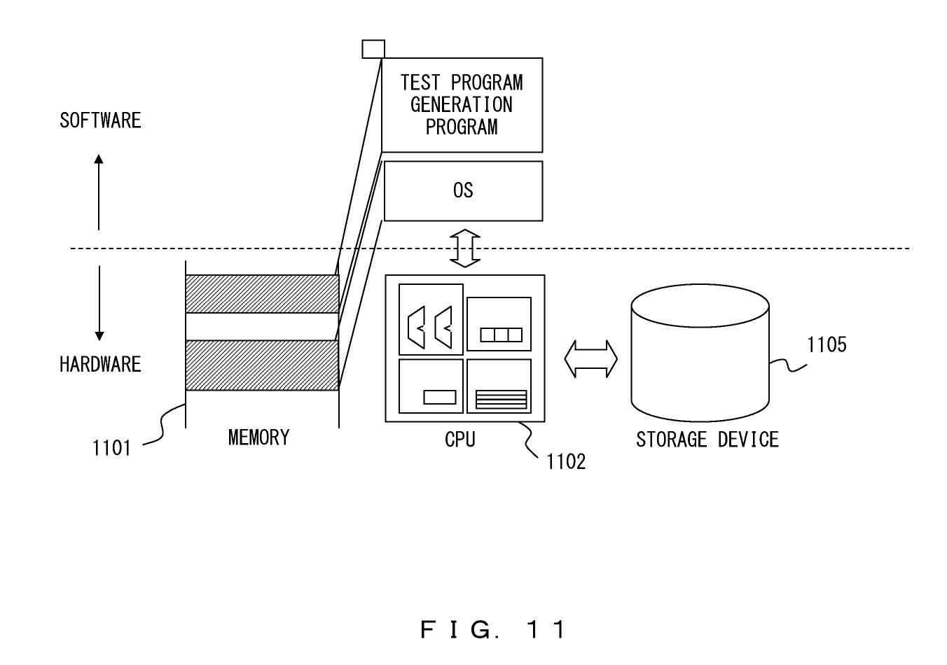

FIG. 11 is a schematic illustrating a portion of a test program generating apparatus 1100 for generating a test program.

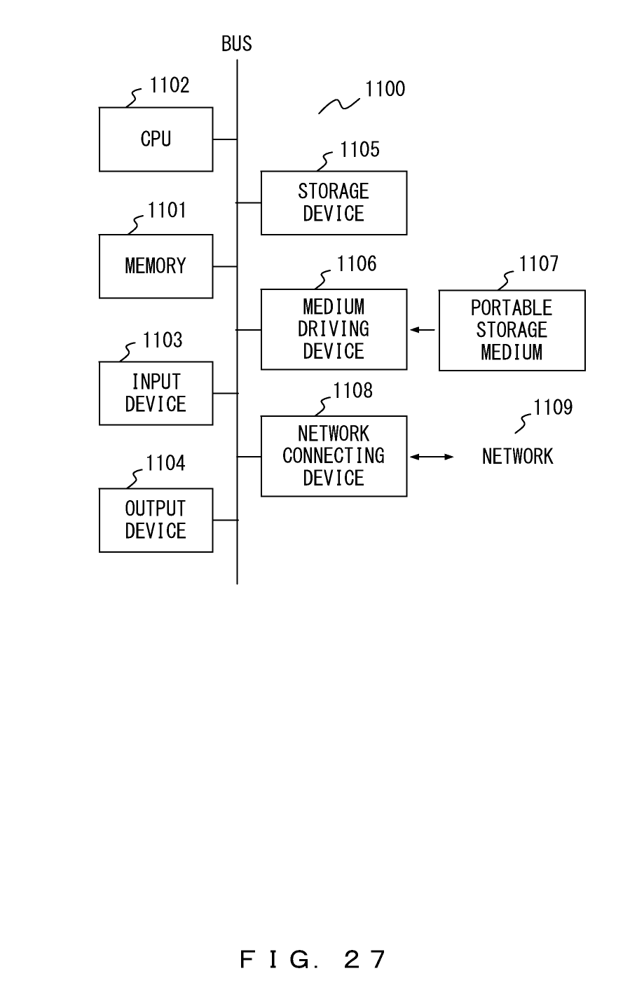

The test program generating apparatus 1100 is an information processing device including a memory 1101, a CPU 1102 and a storage device 1105. A configuration example is illustrated in FIG. 27.

The memory 1101 stores an OS, a program for generating a test program, and the like. For example, a volatile memory such as a RAM (Random Access Memory) or the like, or a nonvolatile memory such as a flash memory or the like may be used as the memory 1101.

The CPU 1102 executes an OS or the test program generation program expanded in the memory 1101. Then, the CPU 1102 generates a test program according to the test program generation program. As will be described later, the CPU 1102 may be a CPU including a mechanism for executing instructions one by one.

The storage device 1105 stores the OS, the test program generation program, and the like in addition to an execution history needed to generate a test program.

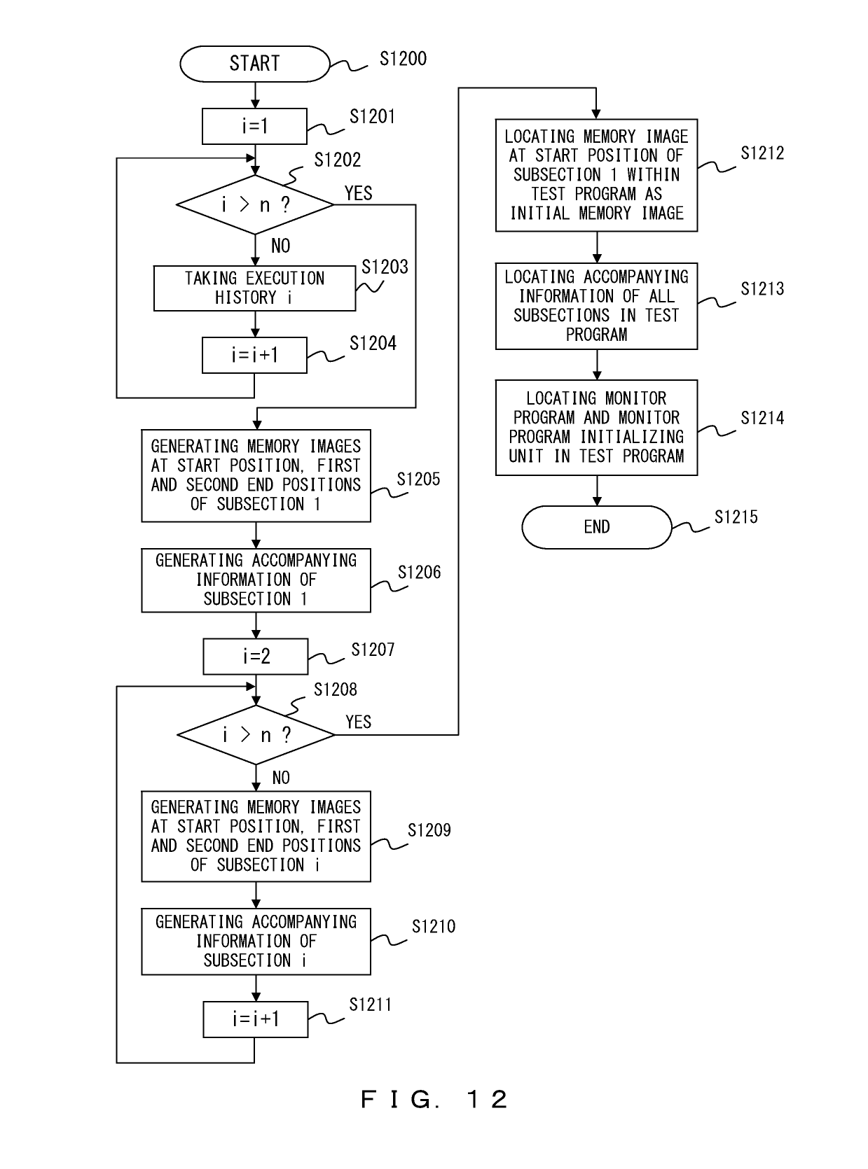

FIG. 12 is a flowchart illustrating an outline of a test program generation process.

By being caused to execute the test program generation program, the test program generating apparatus 1100 starts the test program generation process according to the test program generation program (step S1200).

In step S1201, the test program generating apparatus 1100 sets a variable i to 1.

In step S1202, if the variable i exceeds the number n of all subsections (“YES” in step S1202), the test program generating apparatus 1100 moves the process to step S1205. Alternatively, if the variable i is equal to or smaller than the number n of all the subsections (“NO” in step S1202), the test program generating apparatus 1100 moves the process to step S1203. In this case, the test program generating apparatus 1100 takes an execution history i of a subsection i by causing the original program to run on a CPU emulator (step S1203).

In step S1204, the test program generating apparatus 1100 increments the variable i by 1. Then, the test program generating apparatus 1100 moves the process to step S1202.

In the meantime, in step S1205, the test program generating apparatus 1100 generates memory images respectively at the start position, the first end position and the second end position of the subsection 1 based on an execution history 1. In step S1206, the test program generating apparatus 1100 generates accompanying information of the subsection 1 based on the execution history 1, and the memory images at the start position, the first end position and the second end position of the subsection 1.

In step S1207, the test program generating apparatus 1100 sets the variable i to 2.

If the variable i exceeds the number n of all the subsections in step S1208 (“YES” in step S1208), the test program generating apparatus 1100 moves the process to step S1212. Alternatively, if the variable i is equal to or smaller than the number n of all the subsections (“NO” in step S1208), the test program generating apparatus 1100 moves the process to step S1209. In this case, the test program generating apparatus 1100 generates a memory image at the start position of the subsection i, also generates memory images at the first end position and the second end position, based on the execution history i (step S1209). In step S1210, the test program generating apparatus 1100 generates accompanying information of the subsection i based on the execution history i, and the start position, the first end position and the second end position of the subsection i.

In step S1211, the test program generating apparatus 1100 increments the variable i by 1. Then, the test program generating apparatus 1100 moves the process to step S1208.

In step S1212, the test program generating apparatus 1100 locates the memory image at the start position of the subsection 1 at a predetermined address within the test program as an initial memory image of the test program.

In step S1213, the test program generating apparatus 1100 locates accompanying information of all the subsections at predetermined addresses of the test program.

In step S1214, the test program generating apparatus 1100 locates a test program controlling unit, a monitor program and a monitor program initializing unit, which will be described later, at predetermined addresses of the test program.

With the above described process, an executable test program is generated (step S1215).

### 2.1.1. Process for Taking an Execution History

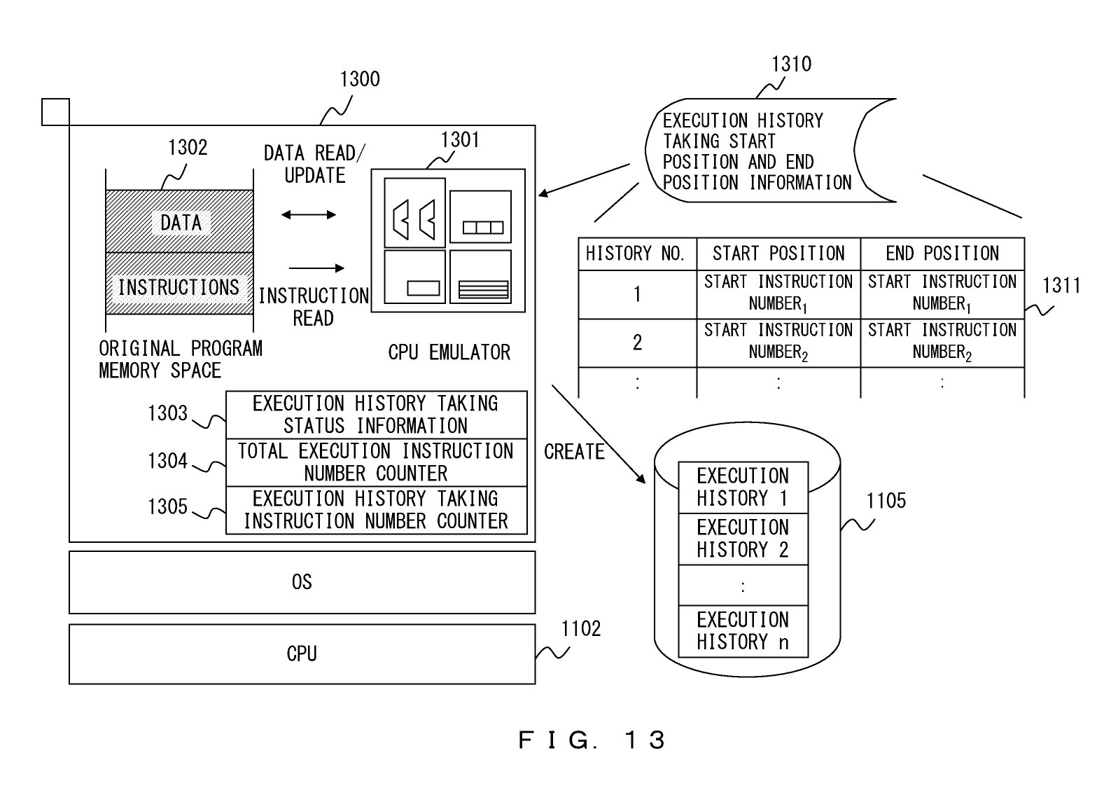

FIG. 13 is an explanatory view of an outline of a process for taking an execution history.

A test program generation program 1300 is a program that runs on an OS installed in the test program generating apparatus 1100. The test program generation program 1300 represents a process implemented by the CPU 1102 executing the test program generation program 1300. The process is described by assuming the test program generation program 1300 merely as an entity in order to clarify the entity of the process.

The test program generation program 1300 causes a CPU emulator 1301 to execute an original program. The CPU emulator 1301 executes the original program by emulating operations of an existing CPU, namely, an already developed CPU used to be compared with a CPU under development.

For example, the CPU emulator 1301 reads instructions one by one from a memory space 1302 where the original program is expanded, and emulates the read instructions. At this time, the CPU emulator 1301 reads, updates, etc. data of the memory space 1302 according to the read instructions.

The memory space 1302 where the original program is expanded is hereinafter referred to as an original program memory space 1302.

While execution history taking status information 1303 is set to “Y”, the test program generation program 1300 takes, as an execution history, the state of the CPU emulated by the CPU emulator 1301, an executed instruction and the like, and stores the execution history in the storage device 1105.

The test program generation program 1300 sets the execution history taking status information 1303 to “Y” when a value of a total executed instruction number counter 1304 reaches a start instruction number specified by execution history taking start position and end position information 1310 to be described later. At this time, the test program generation program 1300 initializes an execution history instruction number counter 1305 to 0. Moreover, the test program generation program 1300 sets the execution history taking status information 1303 to “N” when the value of the execution history instruction number counter 1305 reaches an end instruction number specified by the execution history taking start position and end position information 1310 to be described later.

After causing the CPU emulator 1301 to execute the original program, the test program generation program 1300 increments the count value of the total executed instruction number counter 1304 each time an instruction of the original program is executed by the CPU emulator 1301.

Additionally, when the execution process of the original program by the CPU emulator 1301 enters a subsection, the test program generation program 1300 increments the count value of the execution history instruction number counter 1305 each time an instruction of the original program is executed by the CPU emulator 1301.

The execution history taking start position and end position information 1310 includes execution history taking start position information and execution history taking end position information. The execution history taking start position information may be provided with the number of instructions executed by the CPU emulator 1301 from the execution start position of the original program to a subsection start position. This number of instructions is referred to as a start instruction number. Moreover, the execution history taking end position information may be provided with the number of instructions executed by the CPU emulator 1301, for example, from the subsection start position to a subsection end position. This number of instructions is referred to as an end instruction number.

Additionally, the execution history taking start position and end position information 1310 may specify a start position and an end position for each execution history number as illustrated by a table 1311. As a result, a plurality of subsections may be specified.

FIG. 13 illustrates the case where the CPU emulator 1301 is included in the test program generation program 1300. However, the test program generation program 1300 may not always include the CPU emulator 1301.

FIG. 13 also illustrates the case where the original program memory space 1302 is included in the memory space of the test program generation program 1300. However, the original program memory space 1302 may be allocated to another memory space.

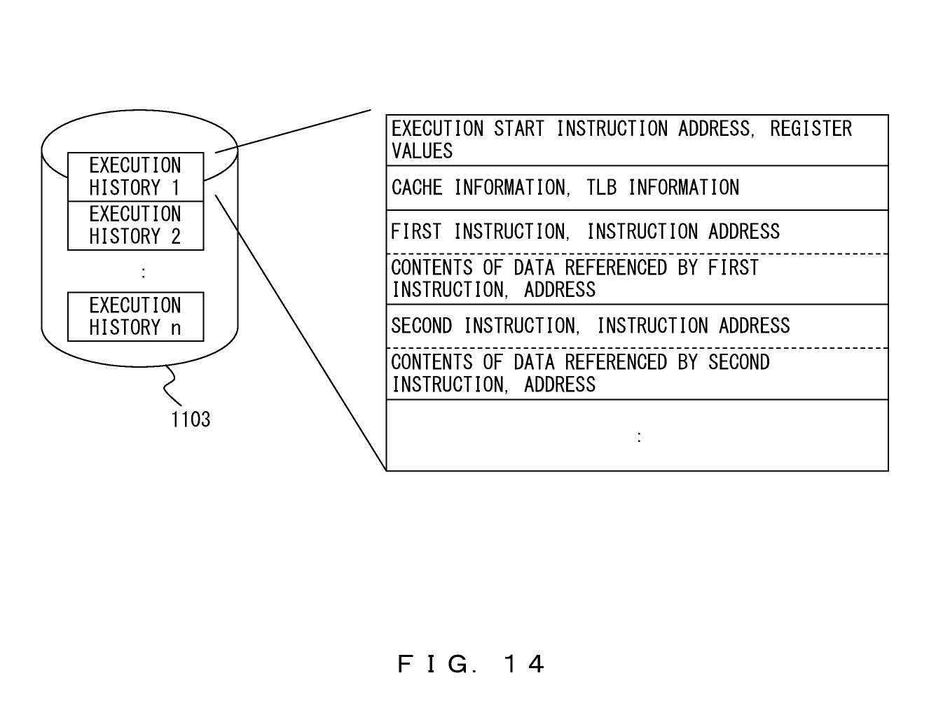

FIG. 14 is an explanatory view of an example of execution histories.

The execution histories are stored in the storage device 1105 in units of subsections. An execution history in a subsection i is referred to as an execution history i.

Each of the execution histories includes an execution start instruction address of a subsection start position, register values and contents of a cache and a TLB. Each of the execution histories additionally includes instructions executed by the CPU emulator 1301 from the subsection start position to the subsection end position, instruction addresses, contents of data referenced when an instruction is executed, and an address of the referenced data.

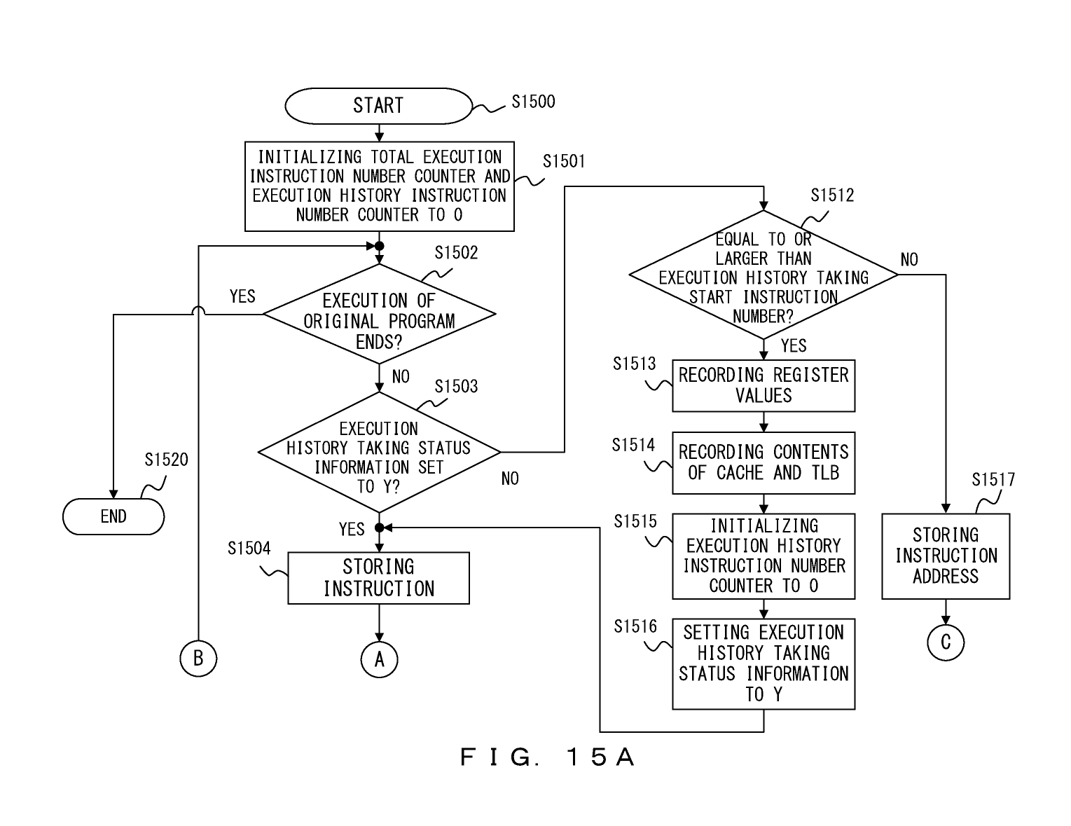

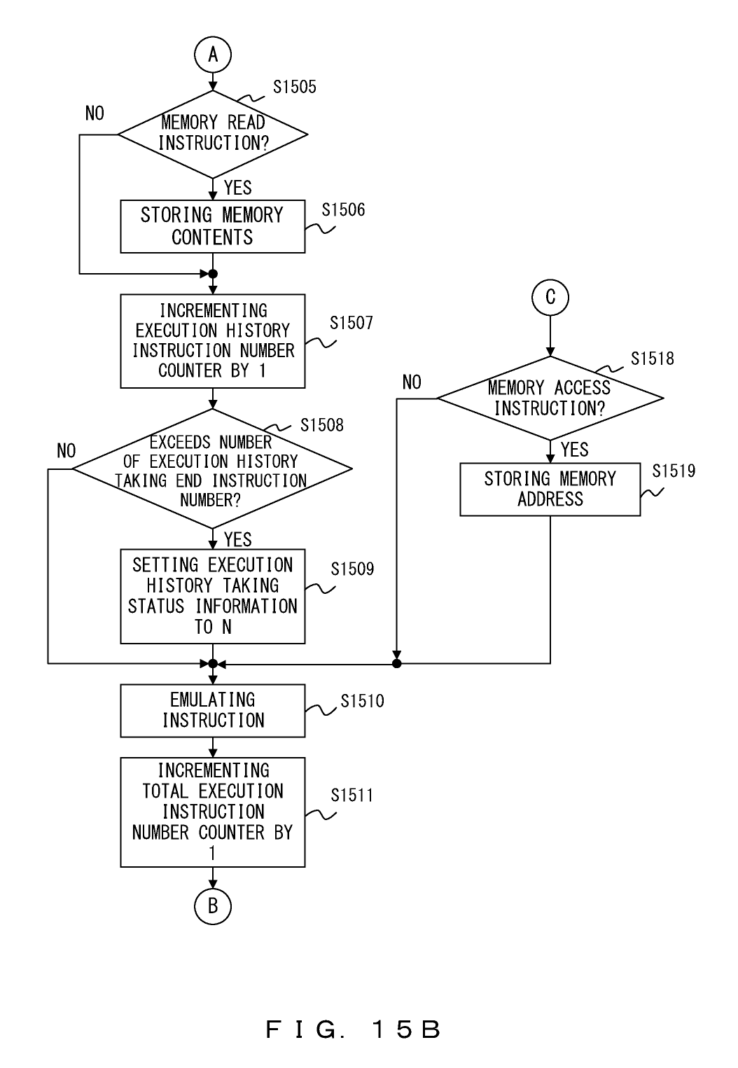

FIGS. 15A and 15B are a flowchart illustrating a process for taking an execution history.

The following process is a process executed by the test program generating apparatus 1100 executing the test program generation program 1300 on the OS. Therefore, this process is described by assuming the test program generating apparatus 1100 as an entity of the process.

In step S1501, the test program generating apparatus 1100 initializes the total executed instruction number counter 1304 and the execution history instruction number counter 1305 to 0. Then, the test program generating apparatus 1100 moves the process to step S1502.

In step S1502, the test program generating apparatus 1100 determines whether or not the original program has been executed. If determining that the original program has been executed (“YES” in step S1502), the test program generating apparatus 1100 moves the process to step S1520, in which the test program generating apparatus 1100 terminates the process for taking an execution history (step S1520). Alternatively, if determining that the original program has not been executed yet (“NO” in step S1502), the test program generating apparatus 1100 moves the process to step S1503, in which the test program generating apparatus 1100 references the execution history taking status information 1303. Then, the test program generating apparatus 1100 determines whether or not the execution history taking status information 1303 is set to “Y” (step S1503).

If the execution history taking status information 1303 is set to “N” (“NO” in step S1503), the test program generating apparatus 1100 moves the process to step S1512. Alternatively, if the execution history taking status information 1303 is set to “Y” (“YES” in step S1503), the test program generating apparatus 1100 moves the process to step S1504. In this case, the test program generating apparatus 1100 reads an instruction pointed to by a PC (Program Counter) within the CPU emulator 1301 from the memory space where the original program is expanded, and stores the read instruction in the storage device 1105 as an execution history (step S1504).

In step S1505, the test program generating apparatus 1100 determines whether or not the instruction read in step S1504 is a memory read instruction. If the instruction read in step S1504 is an instruction other than the memory read instruction (“NO” in step S1505), the test program generating apparatus 1100 moves the process to step S1507. Alternatively, if the instruction read in step S1504 is the memory read instruction (“YES” in step S1505), the test program generating apparatus 1100 moves the process to step S1506. In this case, the test program generating apparatus 1100 stores contents of the memory read by the instruction read in step S1504 in the storage device 1105 as an execution history (step S1506). The “contents of the memory read by the instruction” include the data read by the instruction read in step S1504 and an address where the data is stored.

In step S1507, the test program generating apparatus 1100 increments the execution history instruction number counter 1305 by 1.

In step S1508, if the value of the execution history instruction number counter 1305 is equal to or smaller than a specified execution history taking end instruction number (“NO” in step S1508), the test program generating apparatus 1100 moves the process to step S1510. Note that the execution history taking end instruction number may be provided by the execution history taking start position and end position information 1310 as illustrated in FIG. 13.

If the value of the execution history instruction number counter 1305 exceeds the specified execution history taking end instruction number (“YES” in step S1508), the test program generating apparatus 1100 moves the process to step S1509. In this case, the test program generating apparatus 1100 sets the execution history taking status information 1303 to “N” (step S1509). Then, the test program generating apparatus 1100 moves the process to step S1510.

In step S1510, the test program generating apparatus 1100 causes the CPU emulator 1301 to emulate the instruction read in step S1504. Then, in step S1511, the test program generating apparatus 1100 increments the total executed instruction number counter 1304 by 1. Then, the test program generating apparatus 1100 moves the process to step S1502.

In the meantime, in step S1512, the test program generating apparatus 1100 determines whether or not the value of the total executed instruction number counter 1304 is equal to or larger than the specified execution history taking start instruction number. If the value of the total executed instruction number counter 1304 is smaller than the specified execution history taking start instruction number (“NO” in step S1512), the test program generating apparatus 1100 stores the instruction address in an execution history (step S1517). Then, the test program generating apparatus 1100 moves the process to step S1518. If the value of the total executed instruction number counter 1304 is equal to or larger than the specified execution history taking start instruction number (“YES” in step S1512), the test program generating apparatus 1100 moves the process to step S1513. In this case, the test program generating apparatus 1100 obtains the values of registers from the CPU emulator 1301, and stores the obtained values in the execution history (step S1513). The test program generating apparatus 1100 also obtains the contents of the cache and those of the TLB from the CPU emulator 1301, and stores the obtained contents in the execution history (step S1514).

In step S1515, the test program generating apparatus 1100 initializes the execution history instruction number counter 1305 to 0. In step S1516, the test program generating apparatus 1100 sets the execution history taking status information 1303 to “Y”. Then, the test program generating apparatus 1100 moves the process to step S1504.

In the meantime, in step S1518, the test program generating apparatus 1100 reads the instruction pointed to by the PC within the CPU emulator 1301 from the memory space where the original program is expanded. If the read instruction is a memory access instruction including a read, an update or the like of data in the memory (“YES” in step S1518), the test program generating apparatus 1100 moves the process to step S1519. In this case, the test program generating apparatus 1100 stores an access destination address in the storage device 1105 as accompanying information of the execution history (step S1519). This storage operation is performed to reproduce the contents of the cache and the TLB later. Thereafter, the test program generating apparatus 1100 moves the process to step S1510.

Also if the read instruction is not the memory access instruction including a read, an update or the like of the data in the memory (“NO” in step S1518), the test program generating apparatus 1100 moves the process to step S1510.

In the above described process for taking an execution history, steps S1517, S1518 and S1519 are not always needed. However, if the contents of the cache and the TLB may not be obtained, for example, with the process of step S1514, the contents of the cache and the TLB may be reproduced based on the memory address stored in step S1517 and S1519.

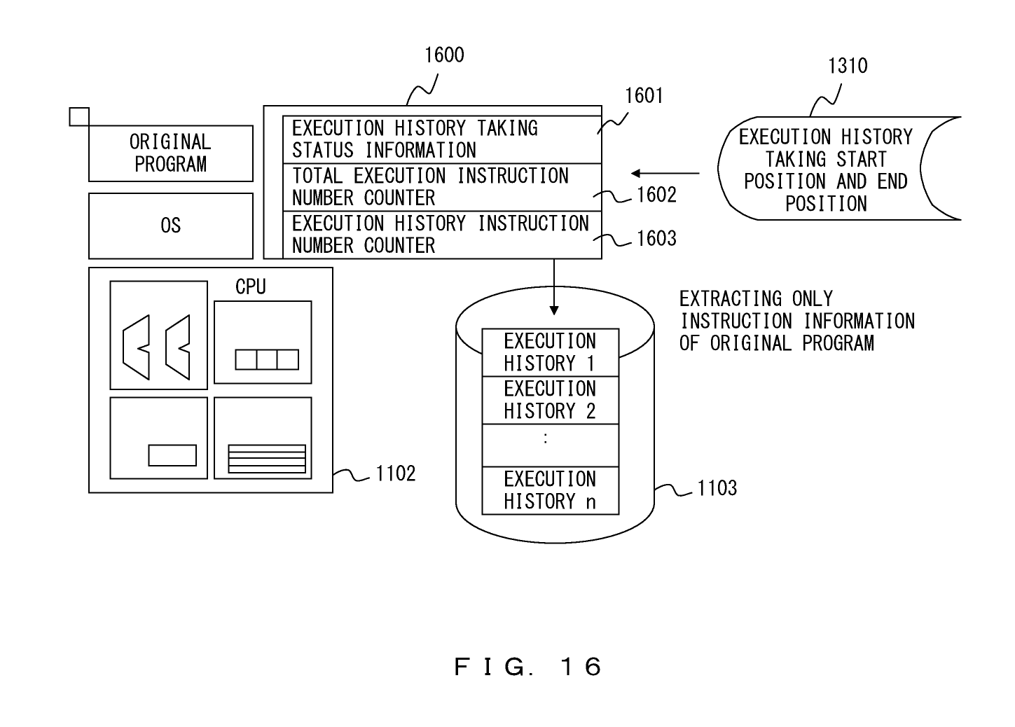

FIG. 16 is an explanatory view of an outline of another example of the process for taking an execution history.

An execution history taking program 1600 for taking an execution history is a program executed independently of the test program generation program 1300. The execution history taking program 1600 is executed in the CPU 1102 included in the test program generating apparatus 1100 not via the OS.

The execution history taking program 1600 illustrated in FIG. 16 indicates a process implemented by the CPU 1102 executing the execution history taking program 1600. This process is described by assuming the execution history taking program 1600 merely as an entity in order to clarify the entity of the process.

When an execution history is taken by using the execution history taking program 1600, the CPU 1102 needs to include a mechanism for executing instructions one by one. The execution history taking program 1600 is called and executed every time the CPU 1102 executes each one arbitrary instruction of the original program or the OS.

For example, if the CPU 1102 executes one arbitrary instruction, the execution history taking program 1600 is called. If the execution history taking status information 1601 is set to “Y” and the instruction executed by the CPU 1102 is an instruction of the original program, the execution history taking program 1600 stores the state of the CPU 1102, the executed instruction and the like in the storage device 1105 as an execution history.

When a value of a total executed instruction number counter 1602 reaches the start instruction number specified by the execution history taking start position and end position information 1310, the execution history taking program 1600 sets the execution history taking status information 1601 to “Y”. At this time, the execution history taking program 1600 initializes the execution history instruction number counter 1603 to 0. Moreover, if the value of the execution history instruction number counter 1603 reaches the end instruction number specified by the execution history taking start position and end position information 1310, the execution history taking program 1600 sets the execution history taking status information 1601 to “N”.

When being called by the CPU 1102, the execution history taking program 1600 increments the total executed instruction number counter 1602 by 1 only when the CPU 1102 executes an instruction of the original program.

Additionally, the execution history taking program 1600 increments the execution history instruction number counter 1603 by 1 only when the CPU 1102 executes a subsection of the original program.

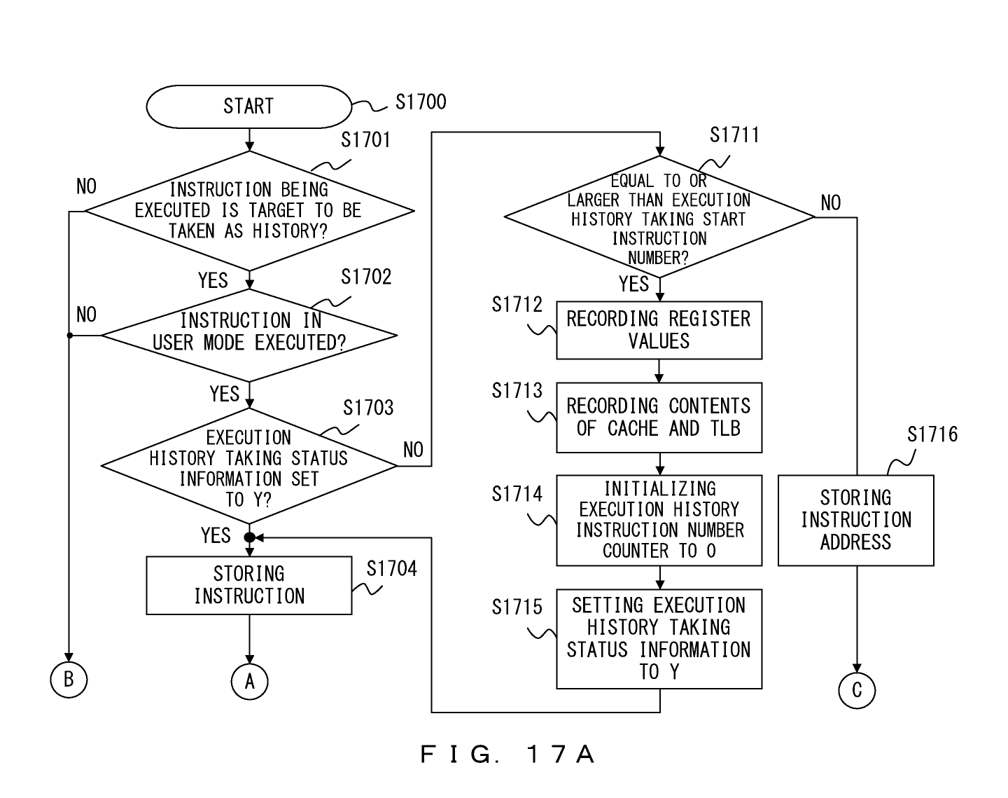

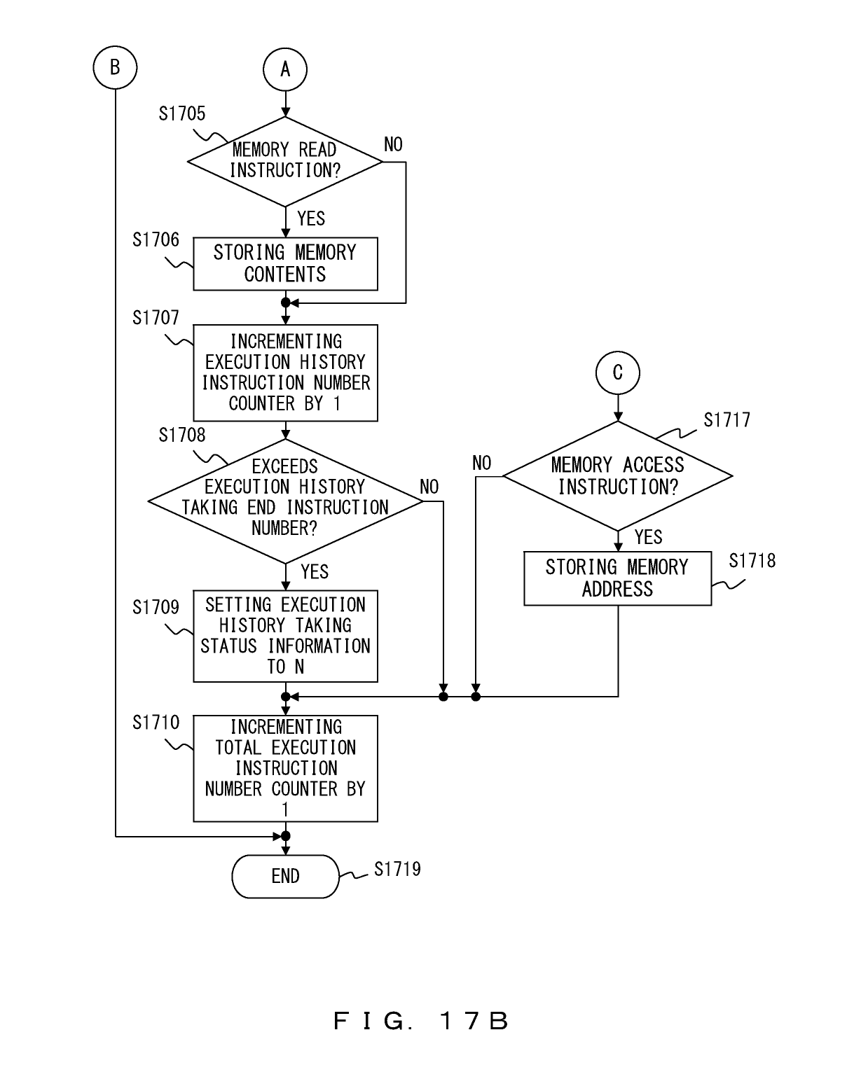

FIGS. 17A and 17B are a flowchart illustrating another example of the process for taking an execution history.

Upon activating the CPU 1102 after making settings for calling the execution history taking program 1600 for each instruction, the CPU 1102 executes the following process by calling the execution history taking program 1600 each time the CPU 1102 executes one arbitrary instruction of the OS, the original program or the like.

The following process is a process executed by the CPU 1102 executing the execution history taking program 1600. However, this process is described by assuming the test program generating apparatus 1100 including the CPU 1102 as an entity in order to clarify the entity of the process.

When the execution history taking program 1600 is initially called, the test program generating apparatus 1100 starts the process for taking an execution history after initializing the total executed instruction number counter 1602 and the execution history instruction number counter 1603 (step S1700).

In step S1701, the test program generating apparatus 1100 determines whether or not an instruction executed immediately before calling the execution history taking program 1600 is a target to be taken as an execution history. The instruction executed immediately before calling the execution history taking program 1600 is hereinafter referred to as an “executed instruction”.

For example, if an instruction address of the executed instruction is included within an area of the original program expanded in the memory, the test program generating apparatus 1100 may determine that the executed instruction is a target to be taken as an execution history.

If determining that the executed instruction is not the target to be taken as an execution history (“NO” in step S1701), the test program generating apparatus 1100 moves the process to step S1719, in which the test program generating apparatus 1100 terminates the process for taking an execution history. Alternatively, if determining that the executed instruction is the target to be taken as the execution history (“YES” in step S1701), the test program generating apparatus 1100 moves the process to step S1702.

In step S1702, the test program generating apparatus 1100 determines whether or not the executed instruction has been executed in the user mode. If the executed instruction has been executed in the privilege mode (“NO” in step S1702), the test program generating apparatus 1100 moves the process to step S1719, in which the test program generating apparatus 1100 ends the process for taking an execution history. This is because the original program is a program to be executed in the user mode.

If the executed instruction is executed in the user mode (“YES” in step S1702), the test program generating apparatus 1100 moves the process to step S1703. In this case, the test program generating apparatus 1100 references the execution history taking status information 1601. Then, the test program generating apparatus 1100 determines whether or not the execution history taking status information 1601 is set to “Y” (step S1703).

If the execution history taking status information 1601 is set to “N” (“NO” in step S1703), the test program generating apparatus 1100 moves the process to step S1711. Alternatively, if the execution history taking status information 1601 is set to “Y” (“YES” in step S1703), the test program generating apparatus 1100 moves the process to step S1704. In this case, the test program generating apparatus 1100 stores the executed instruction in the storage device 1105 as an execution history (step S1704).

In step S1705, the test program generating apparatus 1100 determines whether or not the instruction obtained in step S1704 is a memory read instruction. If the instruction obtained in step S1704 is an instruction other than the memory read instruction (“NO” in step S1705), the test program generating apparatus 1100 moves the process to step S1707. Alternatively, if the instruction read in step S1704 is the memory read instruction (“YES” in step S1705), the test program generating apparatus 1100 moves the process to step S1706. In this case, the test program generating apparatus 1100 stores memory contents read by the instruction obtained in step S1704 in the storage device 1105 as an execution history (step S1706). The memory contents read by the instruction is information including data read by the instruction read in step S1704, and an address where the data is stored.

In step S1707, the test program generating apparatus 1100 increments the execution history instruction number counter 1603 by 1.

If the value of the execution history instruction number counter 1603 is equal to or smaller than a specified execution history taking end instruction number in step S1708 (“NO” in step S1708), the test program generating apparatus 1100 moves the process to step S1710. The execution history taking end instruction number may be provided by the execution history taking end position information of the execution history taking start position and end position information 1310 as illustrated in FIG. 13.

If the value of the execution history instruction number counter 1603 exceeds the specified execution history taking end instruction number (“YES” in step S1708), the test program generating apparatus 1100 moves the process to step S1709. In this case, the test program generating apparatus 1100 sets the execution history taking status information 1601 to “N”, and moves the process to step S1710.

In step S1710, the test program generating apparatus 1100 increments the total executed instruction number counter 1602 by 1. Then, the test program generating apparatus 1100 moves the process to step S1719, in which the test program generating apparatus 1100 terminates the process for taking an execution history.

In the meantime, the test program generating apparatus 1100 determines whether or not the value of the total executed instruction number counter 1602 is equal to or larger than the specified execution history taking start instruction number. If the value of the total executed instruction number counter 1602 is smaller than the specified execution history taking start instruction number (“NO” in step S1711), the test program generating apparatus 1100 moves the process to step S1716. If the value of the total executed instruction number counter 1602 is equal to or larger than the specified execution history taking start instruction number (“YES” in step S1711), the test program generating apparatus 1100 moves the process to step S1712. In this case, the test program generating apparatus 1100 obtains values of registers from the CPU, and stores the obtained values in the execution history (step S1712). Moreover, the test program generating apparatus 1100 obtains contents of the cache and the TLB from the CPU, and stores the obtained contents in the execution history (step S1713).

In step S1714, the test program generating apparatus 1100 initializes the execution history instruction number counter 1603 to 0. Then, in step S1715, the test program generating apparatus 1100 sets the execution history taking status information 1601 to “Y”, and moves the process to step S1704.

In the meantime, the test program generating apparatus 1100 stores the instruction address in the execution history (step S1716). Then, the test program generating apparatus 1100 moves the process to step S1717. If the executed instruction is a memory access instruction including a read, an update or the like of data in the memory (“YES” in step S171), the test program generating apparatus 1100 stores an access destination address in the storage device 1105 as accompanying information of the execution history (step S1718). This storage operation is performed to reproduce the contents of the cache and the TLB later. Thereafter, the test program generating apparatus 1100 moves the process to step S1710.

Alternatively, if the read instruction is not the memory access instruction including a read, an update or the like of the data in the memory (“NO” in step S1717), the test program generating apparatus 1100 moves the process to step S1710.

In the above described process for taking an execution history, the processes in steps S1716, S1717 and S1718 are not always needed. However, if the contents of the cache and the TLB may not be obtained, for example, with the process of S1713, the contents of the cache and the TLB may be reproduced based on the memory address stored in step S1716 and S1718.

### 2.1.2. Process for Generating a Test Program Based on an Execution History

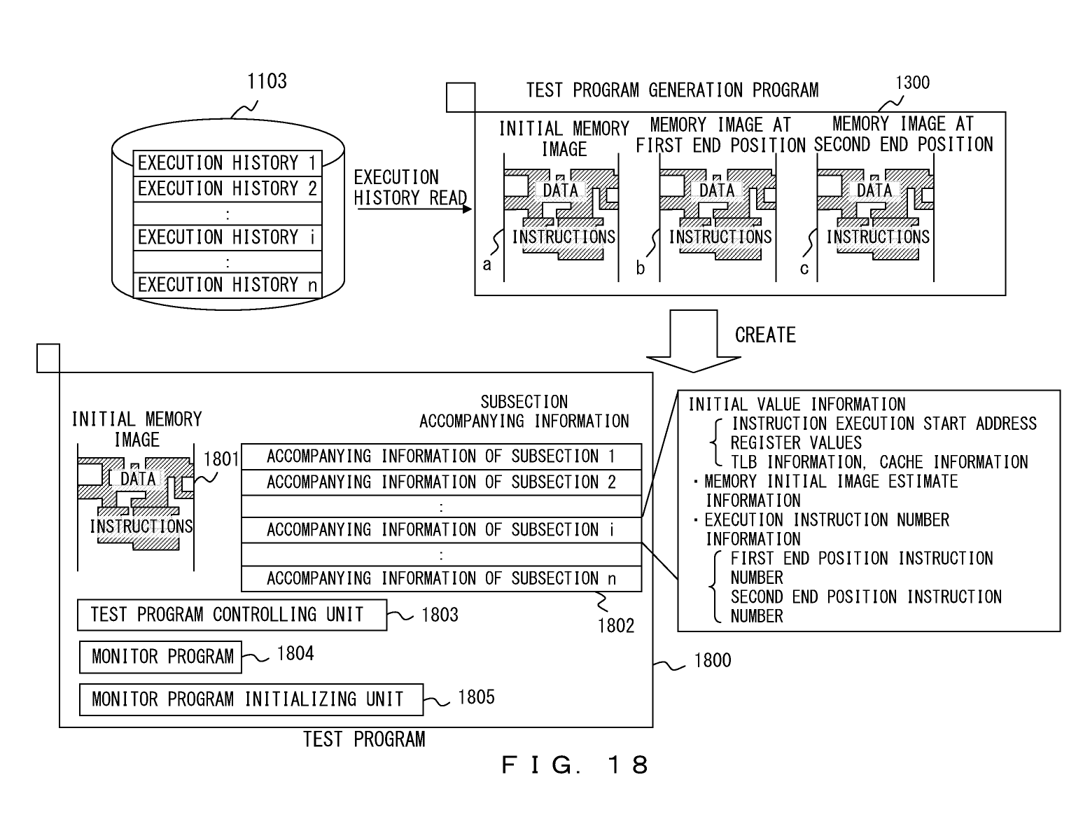

FIG. 18 is an explanatory view of a flow of the process for generating a test program 1800.

The test program generating apparatus 1100 generates, from an execution history 1 stored in the storage device 1105, an initial memory image 1801 that is expanded in the memory and used to implement a memory space at a program execution start position of the test program. For ease of understanding, FIG. 18 illustrates a state where the initial memory image 1801 is expanded in the memory.

Additionally, the test program generating apparatus 1100 generates an initial memory image a of a subsection i, a memory image b at a first end position, and a memory image c at a second end position according to the execution history i stored in the storage device 1105.

The initial memory image a of the subsection i is data that is expanded in the memory and used to generate the initial memory space 1004 illustrated in FIG. 10. Additionally, the memory image b at the first end position in the subsection i is data that is expanded in the memory and used to generate the memory space 1002 at the first end position illustrated in FIG. 10. Furthermore, the memory image c at the second end position in the subsection i is data that is expanded in the memory and used to generate the memory space 1003 at the second end position illustrated in FIG. 10. For ease of understanding, FIG. 18 illustrates the state where the initial memory image a, the memory image b at the first end position, and the memory image c at the second end position are respectively expanded in the memory.

The test program generating apparatus 1100 generates accompanying information of the subsection i based on the execution history i, the initial memory image a of the subsection i, the memory image b at the first end position, and the memory image c at the second end position, and the like. Accompanying information of the subsection 1, accompanying information of the subsection 2, . . . , and accompanying information of the subsection n are referred to generically as subsection accompanying information 1802.

Lastly, the test program generating apparatus 1100 generates an executable test program 1800 by making an association among the initial memory image 1801, the subsection accompanying information 1802, the test program controlling unit 1803, the monitor program 1804 and the monitor program initializing unit 1805.

The test program 1800 generated as described above includes the initial memory image 1801, the subsection accompanying information 1802, the test program controlling unit 1803, the monitor program 1804 and the monitor program initializing unit 1805.

The initial memory image 1801 is data used when the test program 1800 is executed, namely, the data used to implement the memory space at the first start position of the subsection 1.

The subsection accompanying information 1802 is accompanying information provided for each subsection, and includes the accompanying information of the subsection 1, the accompanying information of the subsection 2, . . . , and the accompanying information of the subsection n. For example, as illustrated in FIG. 18, the accompanying information of the subsection i may include initial value information, memory initial state estimate information, and executed instruction number information.

The initial value information is information indicating the state of the CPU at the start position of the subsection n. The initial value information may include an instruction address at the start position of the subsection n, register values at the start position of the subsection, TLB information indicating contents of the TLB at the start position of the subsection, cache information indicating contents of the cache at the start position of the subsection, and the like.

The memory initial state estimate information is information that indicates a difference between a memory space at the end position of a preceding subsection n-1 and the memory space at the start position of the subsection n. The memory space at the start position of the subsection n may be estimated based on the memory space at the end position of the preceding subsection n-1, and the memory initial state estimate information. The estimate of the memory space is as described above with reference to FIGS. 8 to 10.

The executed instruction number information may include the number of instructions from the start position to the second end position of the subsection n, and the number of instructions from the start position to the first end position of the subsection n. This information may also be used to estimate a memory space.

The test program controlling unit 1803 executes the test program 1800 by controlling the whole of the test program 1800. For example, the test program 1800 reads the accompanying information of the subsection n upon completing the execution of the subsection n-1. Then, the test program controlling apparatus 1803 initializes the state of the CPU according to the initial value information, and generates the initial memory space of the subsection n based on the memory space at the end position of the subsection n-1 and the memory initial image estimate information. Then, the test program controlling apparatus 1803 causes the test program 1800 to start to execute the subsection n.

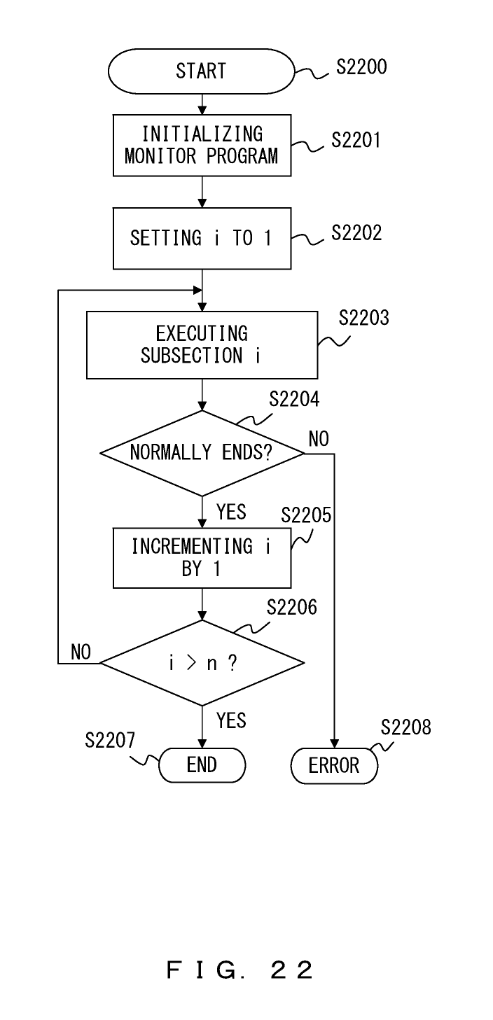

Specific contents of the test program controlling unit 1803 will be described later with reference to FIGS. 22, 23, 25 and 26.

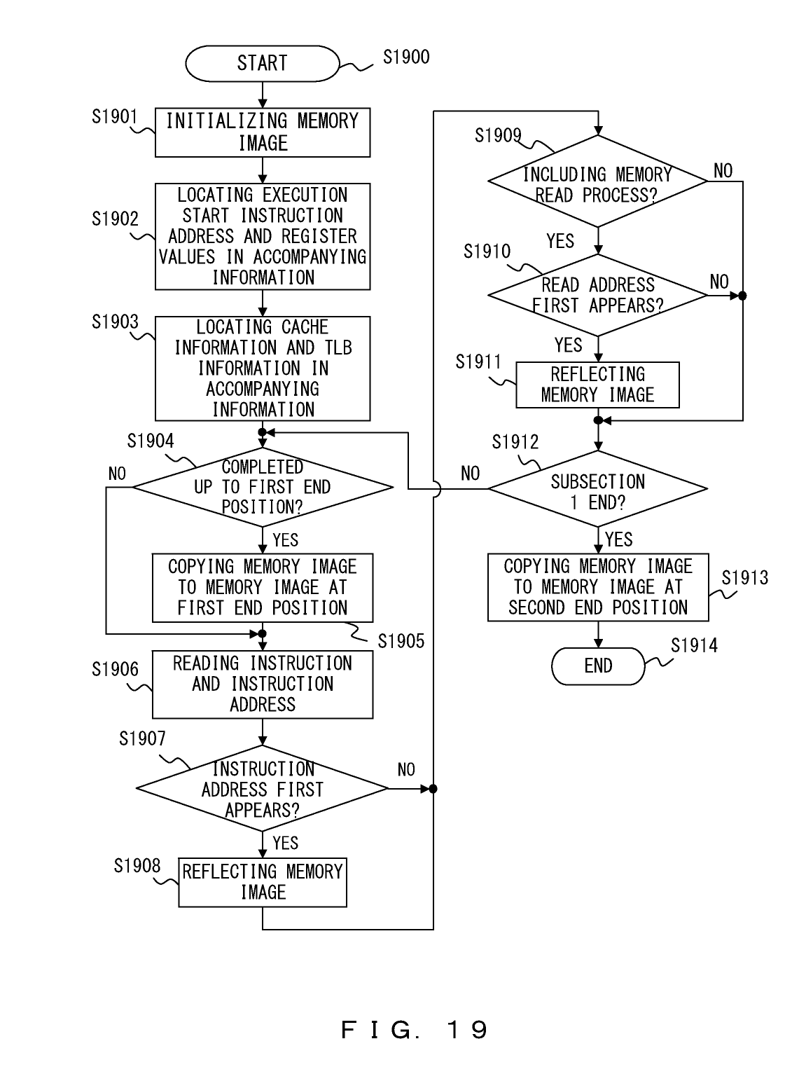

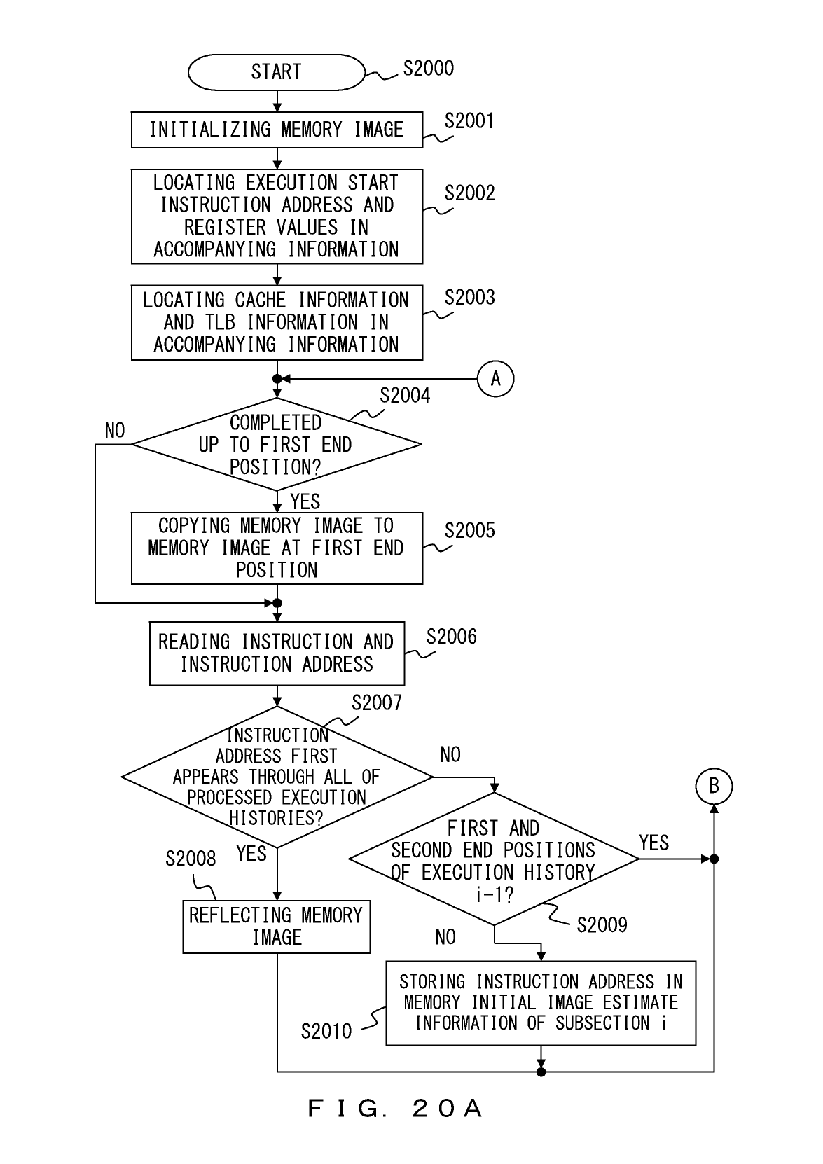

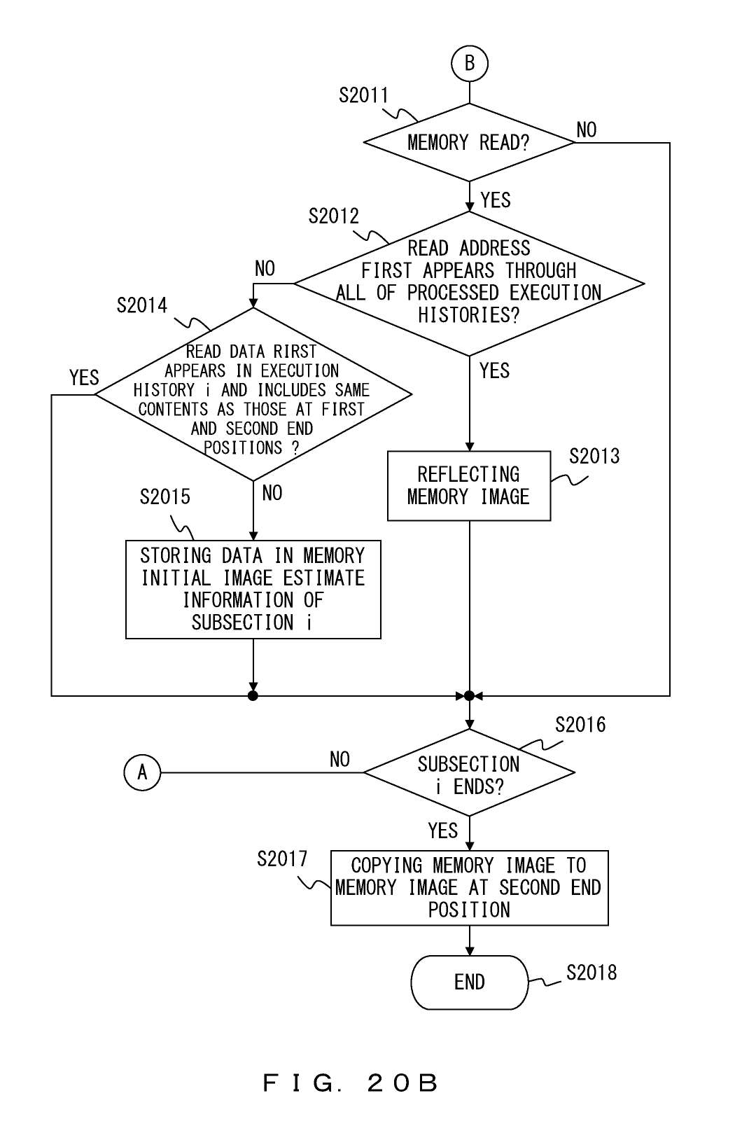

The monitor program 1804 provides minimal services that are needed to execute the test program 1800 and are to be provided by the OS or the like. The monitor program 1804 may be prepared in advance. In this case, functions needed to execute the test program 1800 may be embedded in the monitor program 1804 in advance. The monitor program 1804 may be generated, for example, by embedding only a function to detect a service requested of the OS with a system call or the like and to provide the detected service in step S1906, S2006 or the like at the time of a process for taking an execution history illustrated in FIG. 19 or 20 to be described later.

The monitor program initializing unit 1805 initializes the monitor program 1804 to a state of being expanded in the memory and executable in the privilege mode. For example, the monitor program initializing unit 1805 makes settings for calling the monitor program 1804 if a system call is issued when the test program 1800 is executed. The monitor program initializing unit 1805 may be prepared in advance.

FIG. 19 is a flowchart illustrating a process of step S1205 illustrated in FIG. 12.

In step S1901, the test program generating apparatus 1100 initializes a memory image to be generated after this.

In step S1902, the test program generating apparatus 1100 references the execution history 1 stored in the storage device 1105, and reads an execution start instruction address and register values. Then, the test program generating apparatus 1100 locates the read execution start instruction address and register values at predetermined positions of the accompanying information of the subsection 1 within the test program 1800.

In step S1903, the test program generating apparatus 1100 references the execution history 1 stored in the storage device 1105, and reads the cache information and the TLB information. Then, the test program generating apparatus 1100 locates the read cache information and TLB information at predetermined positions of the accompanying information of the subsection 1 within the test program 1800.

In step S1904, the test program generating apparatus 1100 determines whether or not the process has been completed up to the first end position of the subsection 1. For example, the test program generating apparatus 1100 may determine that the process has been completed up to the first end position of the subsection 1 if the number of instructions read from the execution history 1 exceeds a predetermined number of instructions.

If determining that the process has been completed up to the first end position (“YES” in step S1904), the test program generating apparatus 1100 moves the process to step S1905. In this case, the test program generating apparatus 1100 copies the memory image to the memory image at the first end position (step S1905). Then, the test program generating apparatus 1100 moves the process to step S1906. Alternatively, if determining that the process has not been completed up to the first end position (“NO” in step S1904), the test program generating apparatus 1100 moves the process to step S1906.

In step S1906, the test program generating apparatus 1100 reads an nth instruction and an address of the instruction from the execution history 1. n is a natural number equal to or larger than 1.

In step S1907, the test program generating apparatus 1100 determines whether or not the instruction address read in step S1906 first appears. If the instruction address first appears (“YES” in step S1907), the test program generating apparatus 1100 moves the process to step S1908. In this case, the test program generating apparatus 1100 reflects the read instruction on an address that is an address within the memory image and corresponds to the instruction address of the instruction read in step S1906 (step S1908). Then, the test program generating apparatus 1100 moves the process to step S1909. Alternatively, if the instruction address read in step S1906 does not first appear (“NO” in step S1907), the test program generating apparatus 1100 moves the process to step S1909.

In step S1909, the test program generating apparatus 1100 determines whether or not the instruction read in step S1906 includes a memory read process. If the instruction read in step S1906 does not include the memory read process (“NO” in step S1909), the test program generating apparatus 1100 moves the process to step S1912. Alternatively, if the instruction read in step S1906 includes the memory read process (“YES” in step S1909), the test program generating apparatus 1100 moves the process to step S1910. In this case, the test program generating apparatus 1100 determines whether or not an address of data read by the instruction read in step S1906 first appears (step S1910).

If the address of the read data does not first appears (“NO” in step S1910), the test program generating apparatus 1100 moves the process to step S1912. Alternatively, if the address of the read data first appears (“YES” in step S1910), the test program generating apparatus 1100 moves the process to step S1911. In this case, the test program generating apparatus 1100 reflects the read data on an address that is an address within the memory image and corresponds to the address of the data read by the instruction read in step S1906 (step S1911).

In step S1912, the test program generating apparatus 1100 determines whether or not the process has been completed for the subsection, namely, up to the nth instruction stored in the execution history 1.

If the process has not been completed for the subsection 1 (“NO” in step S1912), the test program generating apparatus 1100 moves the process to step S1904.

Alternatively, if the process has been completed for the subsection 1 (“YES” in step S1912), the test program generating apparatus 1100 moves the process to step S1913. In this case, the test program generating apparatus 1100 copies the memory image to that at the second end position (step S1913).

Upon completing the above described process, the test program generating apparatus 1100 moves the process to step S1206 illustrated in FIG. 12.

In step S1206, the test program generating apparatus 1100 completes the accompanying information of the subsection i by locating the first end position instruction number and the second end position instruction number in the executed instruction number information of the accompanying information of the subsection i within the test program generating apparatus 1100.

Note that memory initialization image estimate information of the accompanying information of the subsection 1 may not be generated. This is because the initial memory image of the subsection 1 is the same as the initial memory image 1801 of the test program 1800.

FIGS. 20A and 20B are a flowchart illustrating a process of step S1209 illustrated in FIG. 12.

In step S2001, the test program generating apparatus 1100 initializes a memory image to be generated after this.

In step S2002, the test program generating apparatus 1100 references the execution history i stored in the storage device 1105, and reads an execution start instruction address and register values. Then, the test program generating apparatus 1100 locates the read execution start instruction address and register values at predetermined positions of the accompanying information of the subsection i within the test program 1800.

In step S2003, the test program generating apparatus 1100 references the execution history i stored in the storage device 1105, and reads cache information and TLB information. Then, the test program generating apparatus 1100 locates the read cache information and TLB information at predetermined positions of the accompanying information of the subsection i within the test program 1800.

In step S2004, the test program generating apparatus 1100 determines whether or not the process has been completed up to the first end position of the subsection i. For example, if the number of instructions read from the execution history exceeds a predetermined number of instructions, the test program generating apparatus 1100 may determine that the process has been completed up to the first end position of the subsection 1.

If determining that the process has been completed up to the first end position (“YES” in step S2004), the test program generating apparatus 1100 moves the process to step S2005. In this case, the test program generating apparatus 1100 copies the memory image to that at the first end position (step S2005). Then, the test program generating apparatus 1100 moves the process to step S2006. Alternatively, if determining that the process has not been completed up to the first end position (“NO” in step S2004), the test program generating apparatus 1100 moves the process to step S2006.

In step S2006, the test program generating apparatus 1100 reads the nth instruction and the address of the instruction from the execution history i. n is a natural number equal to or larger than 1.

In step S2007, the test program generating apparatus 1100 determines whether or not the instruction address read in step S2006 first appears through all already processed execution histories. If determining that the instruction address read in step S2006 first appears through all the already execution histories (“YES” in step S2007), the test program generating apparatus 1100 moves the process to step S2008. In this case, the test program generating apparatus 1100 reflects the read instruction on an address that is an address within the memory image and corresponds to the instruction address of the instruction read in step S2006 (step S2008). Then, the test program generating apparatus 1100 moves the process to step S2011. Alternatively, if determining that the instruction address read in step S2006 does not first appear through all the already processed execution histories (“NO” in step S2007), the test program generating apparatus 1100 moves the process to step S2009.

In step S2009, the test program generating apparatus 1100 determines whether or not the instruction address read in step S2006 matches those at the first and the second end positions of the execution history i-1.

If the instruction address read in step S2006 does not match those at the first and the second end positions of the execution history i-1 (“NO” in step S2009), the test program generating apparatus 1100 moves the process to step S2010. In this case, the test program generating apparatus 1100 stores the instruction address read in step S2006 as memory initial image estimate information used to reproduce the initial memory space of the subsection i (step S2010). Then, the test program generating apparatus 1100 moves the process to step S2011.

Alternatively, if the instruction address read in step S2006 matches those at the first and the second end positions of the execution history i-1 (“YES” in step S2009), the test program generating apparatus 1100 moves the process to step S2011.

In step S2011, the test program generating apparatus 1100 determines whether or not the instruction read in step S2006 includes a memory read process. If the instruction read in step S2006 does not include the memory read process (“NO” in step S2011), the test program generating apparatus 1100 moves the process to step S2016. Alternatively, if the instruction read in step S2006 includes the memory read process (“YES” in step S2011), the test program generating apparatus 1100 moves the process to step S2012. In this case, the test program generating apparatus 1100 determines whether or not an address of data read by the instruction read in step S2006 first appears through all the already processed execution histories (step S2012).

If the address of the read data first appears through all the already processed execution histories (“YES” in step S2012), the test program generating apparatus 1100 moves the process to step S2013. In this case, the test program generating apparatus 1100 reflects the read data on an address that is an address within the memory image and corresponds to the address of the data read by the instruction read in step S2006 (step S2013). Then, the test program generating apparatus 1100 moves the process to step S2016.

If the address of the read data first appears through all the already processed execution histories (“NO” in step S2012), the test program generating apparatus 1100 moves the process to step S2014. In this case, the test program generating apparatus 1100 determines whether or not the data read at the address of the data read by the instruction read in step S1006 first appears in the execution history i, and whether or not the read data matches those at the first and the second end positions (step S2014).

If determining that the data read at the address of the data read by the instruction read in step S2006 first appears in the execution history i and does not match those at the first and the second end positions (“NO” in step S2014), the test program generating apparatus 1100 moves the process to step S2015. In this case, the test program generating apparatus 1100 stores the data read by the instruction read in step S2006 as memory initial image estimate information used to reproduce the initial memory space of the subsection i. Then, the test program generating apparatus 1100 moves the process to step S2016.

In step S2016, the test program generating apparatus 1100 determines whether or not the process has been completed for the subsection i, namely, up to the nth instruction stored in the execution history i.

If the process has not been completed for the subsection i (“NO” in step S2016), the test program generating apparatus 1100 moves the process to step S2004.

Alternatively, if the process has been completed for the subsection i (“YES” in step S2016), the test program generating apparatus 1100 moves the process to step S2017. In this case, the test program generating apparatus 1100 copies the memory image to that at the second end position (step S2017).

Upon completing the above described process, the test program generating apparatus 1100 moves the process to step S1210 illustrated in FIG. 12.

In step S1210, the test program generating apparatus 1100 makes a comparison among an initial memory image a in the subsection i-1, a memory image b at the first end position of the subsection i, and a memory image c at the second end position of the subsection i. Then, the test program generating apparatus 1100 locates mismatching data resulting from the comparison and an address of the data in the memory initial image estimate information of the accompanying information of the subsection i within the test program 1800.

Additionally, the test program generating apparatus 1100 completes the accompanying information of the subsection i by locating the first end position instruction number and the second end position instruction number in the executed instruction number information of the accompanying information of the subsection i within the test program generating apparatus 1100.

### 2.2 Test Program Execution Process

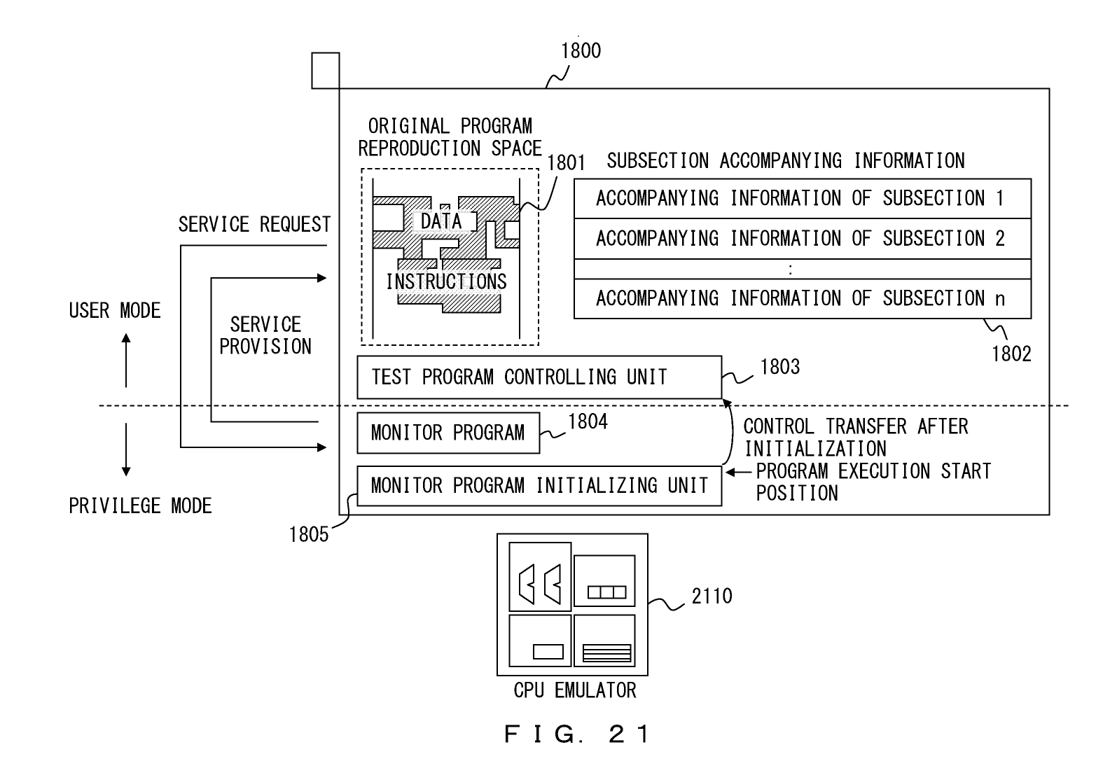

FIG. 21 is an explanatory view of an outline of an execution process when the test program 1800 is executed standalone.

A CPU under development does not exist as hardware that may execute the test program 1800 in many cases. Accordingly, the test program 1800 is executed by using the CPU emulator 2110 that emulates a CPU under development based on a design of the CPU in this embodiment.

In this case, the test program 1800 is executed standalone. Accordingly, the monitor program 1804 provides a service that is needed to execute the test program 1800 and is to be provided by the OS.

The test program 1800 is executed as follows.

(1) Upon activating the CPU emulator 2110 after the test program 1800 is expanded in the memory and the monitor program initializing unit 1805 is specified to execute the test program 1800, the monitor program initializing unit 1805 is made to run. The monitor program initializing unit 1805 initializes the monitor program 1804 to a state executable in the privilege mode. Then, the monitor program initializing unit 1805 transfers a control to the test program controlling unit 1803.

(2) The test program controlling unit 1803 expands the initial memory image 1801 in a predetermined area of the memory space where the test program 1800 is expanded. The predetermined area where the initial memory image 1801 is expanded is referred to as an original program reproduction space.

Additionally, the test program controlling unit 1803 reads register values, TLB information, cache information, and the like from the initial value information of the accompanying information of the subsection 1. Then, the test program controlling unit 1803 initializes the CPU emulator 2110 to a state at the start position of the subsection 1 according to the read register values, TLB information and cache information.

(3) When the test program controlling unit 1803 instructs the CPU emulator 2110 to execute the original program at and after the instruction execution start address indicated by the initial value information of the accompanying information of the subsection 1, the CPU emulator 2110 starts to execute the original program expanded in the original program reproduction space at the instructed instruction execution start address.

If the original program issues a request of a service, such as a TLB miss, a system call or the like, to be provided by the OS while being executed, the monitor program 1804 receives this request. Then, the monitor program 1804 provides the requested service to the original program.

(4) Upon terminating the execution of the subsection 1, a control is transferred from the original program in the original program reproduction space to the test program controlling unit 1803 with an interrupt process or the like.

This process may be implemented by using a CPU function that causes an interrupt after a predetermined number of instructions are executed. The control may be transferred from the original program to the test program controlling unit 1803 with the interrupt process, for example, when instructions are executed by the first end position instruction number specified in the executed instruction number information of the accompanying information of the subsection 1.

(5) The test program controlling unit 1803 verifies whether or not the number of executed instructions of the original program is within a range of the number of instructions, which is set in the executed instruction number information of the accompanying information of the subsection 1, namely, between the first end position instruction number and the second end position instruction number. If the number of executed instructions is not within the range of the number of instructions, which is specified in the executed instruction number information of the accompanying information of the subsection 1, the execution of the test program 1800 is aborted. This is because the program controlling unit 1803 may not estimate an initial memory image a at the start position of the next subsection.

(6) The test program controlling unit 1803 reads memory initial image estimate information from the accompanying information of the subsection 2, which is the accompanying information of the next subsection, and estimates the initial memory image a at the start position of the subsection 2 based on the memory initial image estimate information. Then, the test program controlling unit 1803 expands the estimated initial memory image a at the start position of the subsection 2 in the original program reproduction space.

(7) The test program controlling unit 1803 reads register values, TLB information, cache information, and the like from the initial value information of the accompanying information of the subsection 2. Then, the test program controlling unit 1803 initializes the CPU emulator 2110 to a state at the start position of the subsection 2 according to the read register values, TLB information and cache information.

(8) When the test program controlling unit 1803 instructs the CPU emulator 2110 to execute instructions at and after the instruction execution start address indicated by the initial value information of the accompanying information of the subsection 2, the CPU emulator 2110 starts to execute the original program expanded in the original program reproduction space at the instructed instruction execution start address.

(9) Upon terminating the execution of instructions in the subsection 2, a control is transferred from the original program in the original program reproduction space to the test program controlling unit 1803 with an interrupt process or the like.

(10) The test program controlling unit 1803 verifies whether or not the number of executed instructions of the original program is within a range of the number of instructions, which is set in executed instruction number information of the accompanying information of the subsection 2, namely, between the first end position instruction number and the second end position instruction number. If the number of executed instructions is not within the range of the number of instructions, which is set in the executed instruction number information of the accompanying information of the subsection 2, the execution of the test program 1800 is aborted. This is because the test program controlling unit 1803 may not estimate the initial memory image a at the start position of the next subsection.

Similarly, the above described processes in (6) to (10) are repeatedly executed for all of subsections 3, 4, . . . , n.

FIG. 22 is a flowchart illustrating an outline when the test program 1800 is executed standalone.

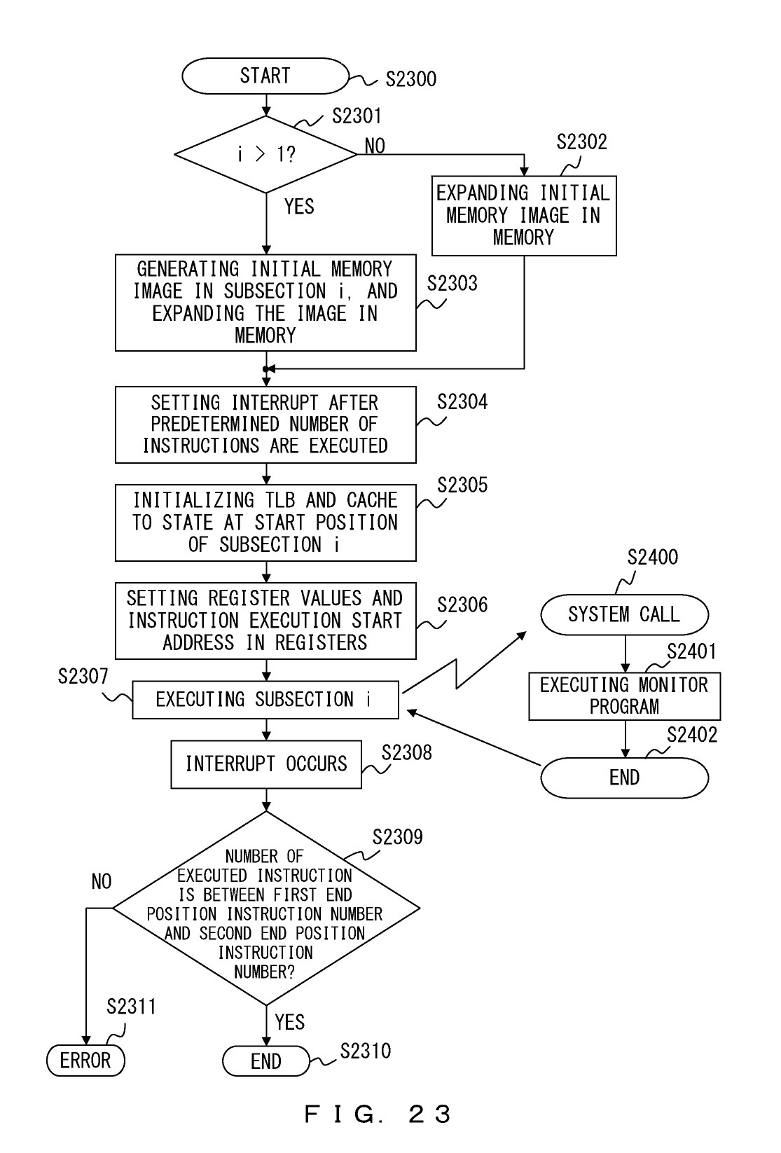

The following process is a process executed by the CPU emulator 2110 executing the test program 1800. This process is described by assuming the executed program as an entity in order to clarify the operations of the test program 1800. FIGS. 23, 25 and 26 are also described by assuming the executed program as an entity.

Upon activating the CPU emulator 2110 after the test program 1800 is expanded in the memory and the monitor program initializing unit 1805 is specified to execute the test program 1800, the monitor program initializing unit 1805 is made to run (step S2200). The monitor program initializing unit 1805 initializes the monitor program 1804 to a state executable in the privilege mode (step S2201).

In step S2202, the test program controlling unit 1803 sets the variable i to 1. Then, in step S2203, the test program controlling unit 1803 executes the subsection i of the original program.

In step S2204, the test program controlling unit 1803 determines whether or not the execution of the original program in step S2203 has been normally terminated. If the execution of the original program in step S2203 has been abnormally terminated (“NO” in step S2204), the program controlling unit 1803 moves the process to step S2208, in which the program is abnormally terminated.

If the execution of the original program in step S2203 is normally terminated (“YES” in step S2204), the test program controlling unit 1803 moves the process to step S2205. In this case, the test program controlling unit 1803 increments the variable i by 1 (step S2205). Then, the test program controlling unit 1803 moves the process to step S2206.

If the variable i is equal to or smaller than the number n of pieces of accompanying information stored in the subsection accompanying information 1802 in step S2206 (“NO” in step S2206), the test program controlling unit 1803 moves the process to step S2203. Alternatively, if the variable i is larger than the number n of pieces of accompanying information stored in the subsection accompanying information 1802 (“YES” in step S2206), the test program controlling unit 1803 moves the process to step S2007, which the execution process of the test program 1800 is terminated.

FIG. 23 is a flowchart illustrating an execution process when the test program 1800 is executed standalone.

In step S2301, the test program controlling unit 1803 determines whether or not the variable i is larger than 1. If the variable i is 1 (“NO” in step S2301), the test program controlling unit 1803 moves the process to step S2302. In this case, the test program controlling unit 1803 expands an initial memory image 1801 in the original program reproduction space (step S2302).

If the variable i is larger than 1 (“YES” in step S2301), the test program controlling unit 1803 moves the process to step S2303. In this case, the test program controlling unit 1803 obtains memory initial image estimate information from the accompanying information of the subsection i. Then, the test program controlling unit 1803 generates the initial memory image a at the start position of the subsection i from the obtained memory initial image estimate information, and expands the generated initial memory image a in the original program reproduction space (step S2303).

In step S2304, the test program controlling unit 1803 obtains a first end position instruction number from executed instruction number information of the accompanying information of the subsection i. Then, the test program controlling unit 1803 makes settings for transferring a control from the original program to the test program controlling unit 1803 by causing an interrupt when instructions of the original program are executed by the first end position instruction number at after the start position of the subsection i.

In step S2305, the test program controlling unit 1803 obtains TLB information and cache information from the initial value information of the accompanying information of the subsection i. Then, the test program controlling unit 1803 initializes the CPU emulator 2110 to the state at the start position of the subsection i by changing contents of the TLB and the cache within the CPU emulator 2110 according to the obtained TLB information and cache information.

In step S2306, the test program controlling unit 1803 obtains an instruction execution start address and register values from the initial value information of the accompanying information of the subsection i. Then, the test program controlling unit 1803 sets the obtained register values in registers within the CPU emulator 2110. Moreover, the test program controlling unit 1803 sets the obtained instruction execution start address in a PC within the CPU emulator 2110.

In step S2307, the CPU emulator 2110 starts to execute the original program expanded in the original program reproduction space when the test program controlling unit 1803 instructs the CPU emulator 2110 to start to execute the original program.

Here, if the original program issues a system call (step S2400), the monitor program 1804 is read and executed (step S2401). The monitor program 1804 provides a requested service to the original program. After providing the requested service, the execution of the monitor program 1804 is terminated (step S2402). Then, the process is moved to step S2307, in which the original program restarts to be executed.

In step S2308, an interrupt occurs when instructions of the original program are executed by the number of instructions, which is specified in step S2304, and a control is transferred from the original program to the test program controlling unit 1803.

If the number of executed instructions in step S2307 is within a range from the first end position instruction number to the second end position instruction number in step S2309 (“YES” in step S2309), the test program controlling unit 1803 moves the process to step S2310. Then, the test program controlling unit 1803 terminates the execution process of the test program 1800. Alternatively, if the number of executed instructions in step S2307 is not within the range from the first end position instruction number to the second end position instruction number (“NO” in step S2309), the test program controlling unit 1803 moves the process to step S2311, in which the execution process of the test program 1800 is abnormally terminated.

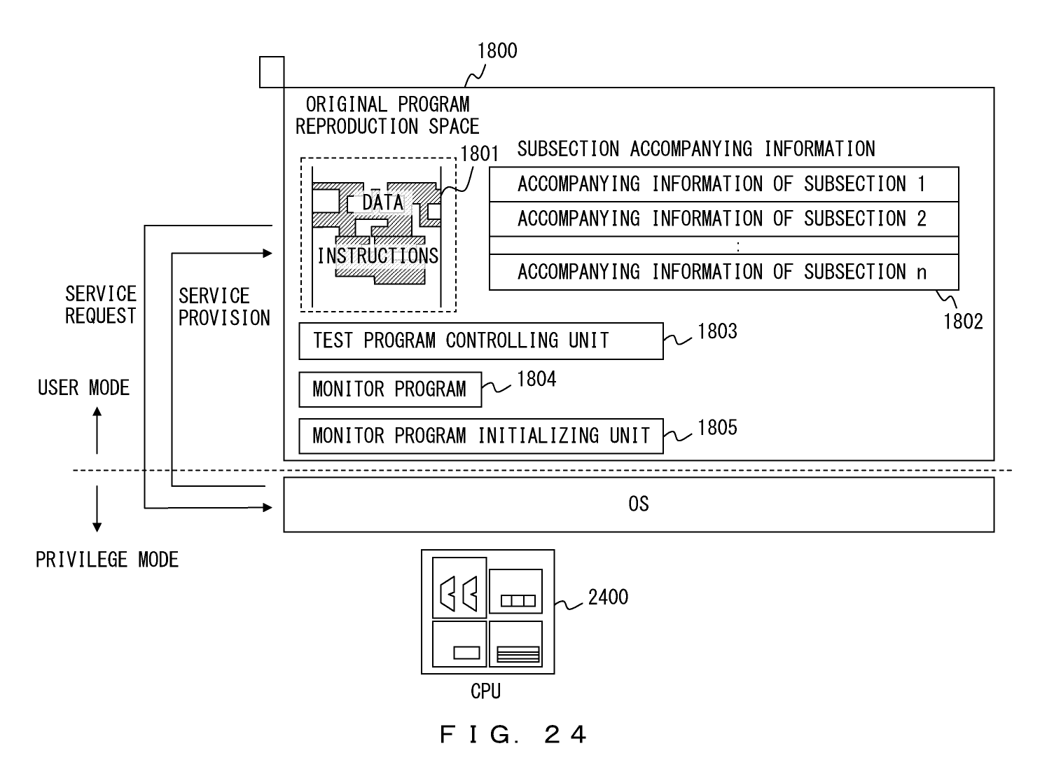

FIG. 24 is an explanatory view of an outline of an execution process when the test program 1800 is executed on the OS.

If the test program 1800 is made to run on an OS, a general information processing device where the OS runs may be used. A CPU 2400 illustrated in FIG. 24 represents a CPU included in a general information processing device.

If the test program 1800 is made to run on the OS, the monitor program 1804 and the monitor program initializing unit 1805, which are included in the test program 1800, are not used. This is because needed services are provided from the OS.

The test program 1800 is executed as follows.

(1) When the OS is instructed to execute the test program 1800, the OS expands the test program 1800 in the memory, and starts to execute the test program 1800. At this time, the test program controlling unit 1803 included in the test program 1800 is made to run.

(2) The test program controlling unit 1803 expands the initial memory image 1801 in the original program reproduction space. Additionally, the test program controlling unit 1803 reads register values, TLB information, cache information, and the like from the initial value information of the accompanying information of the subsection 1. Then, the test program controlling unit 1803 initializes the CPU 2400 to the state at the start position of the subsection 1 according to the read register values, TLB information and cache information.

(3) When being instructed to execute instructions at and after the instruction execution start address indicated by the initial value information of the accompanying information of the subsection 1, the CPU 2400 starts to execute the original program expanded in the original program reproduction space at the instructed instruction execution start address.

Services such as a TLB miss, a system call or the like are provided from the OS while the original program is being executed.

(4) Upon terminating the execution of instructions in the subsection 1, a control is transferred from the original program in the original program reproduction space to the test program controlling unit 1803 with an interrupt process or the like.

This process may be implemented by using a function of the CPU 2400, which causes an interrupt, after a predetermined number of instructions are executed. The control may be transferred from the original program to the test program controlling unit 1803 with the interrupt process, for example, when instructions are executed by the first end position instruction number specified by the executed instruction number information of the accompanying information of the subsection 1.

(5) The test program controlling unit 1803 verifies whether or not the number of executed instructions of the original program is within a range of the number of instructions, which is set in the executed instruction number information of the accompanying information of the subsection 1, namely, between the first end position instruction number and the second end position instruction number. If the number of executed instructions is not within the range of the number of instructions, which is set in the executed instruction number information of the accompanying information of the subsection 1, the execution of the test program 1800 is aborted. This is because the test program controlling unit 1803 may not estimate an initial memory image a at the start position of the next subsection.

(6) The test program controlling unit 1803 reads memory initial image estimate information from accompanying information of the subsection 2, which is the accompanying information of the next subsection, and estimates the initial memory image a at the start position of the subsection 2 based on the memory initial image estimate information. Then, the test program controlling unit 1803 expands the estimated initial memory image a at the start position of the subsection 2 in the original program reproduction space.

(7) The test program controlling unit 1803 reads register values, TLB information, cache information and the like from the initial value information of the accompanying information of the subsection 2. Then, the test program controlling unit 1803 initializes the CPU 2400 to the state at the start position of the subsection 2 according to the read register values, TLB information and cache information.

(8) When the test program controlling unit 1803 instructs the CPU 2400 to execute instructions at and after the instruction execution start address indicated by the initial value information of the accompanying information of the subsection 2, the CPU 2400 starts to execute the original program expanded in the original program reproduction space at the instructed instruction execution start address.

(9) Upon terminating the execution of instructions in the subsection 2, a control is transferred from the original program in the original program reproduction space to the test program controlling unit 1803 with an interrupt process or the like.

(10) The test program controlling unit 1803 verifies whether or not the number of executed instructions of the original program is within a range of the number of instructions, which is set in the executed instruction number information of the accompanying information of the subsection 2, namely, between the first end position instruction number and the second end position instruction number. If the number of executed instructions is not within the range of the number of instructions, which is set in the executed instruction number information of the accompanying information of the subsection 2, the execution of the test program 1800 is aborted. This is because the test program controlling unit 1803 may not estimate an initial memory image a at the start position of the next subsection.

Similarly, the above described processes in (6) to (10) are repeatedly executed for all the subsections, 3, 4, . . . n.

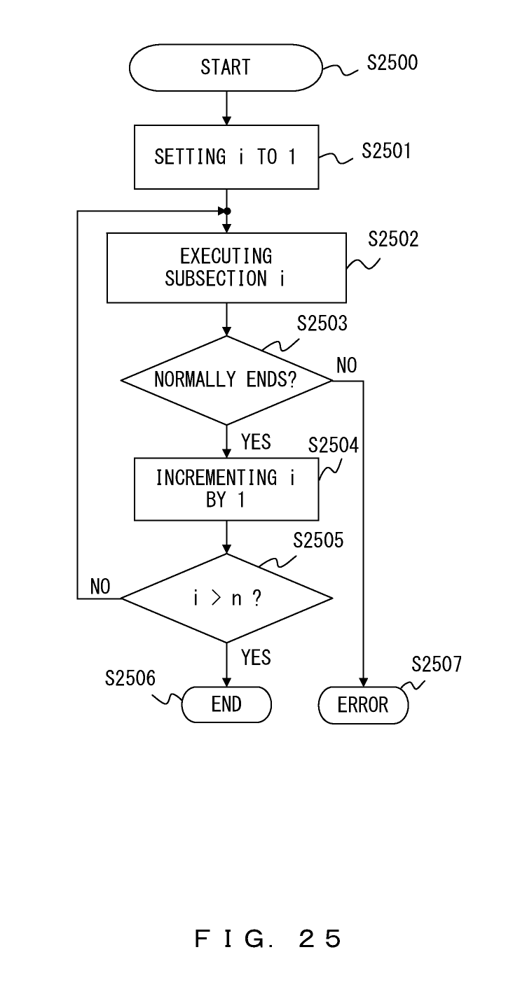

FIG. 25 is a flowchart illustrating an outline when the test program 1800 is executed on the OS.

When the OS is instructed to execute the test program 1800, the OS expands the test program 1800 in the memory, and starts to execute the test program 1800 (step S2500). At this time, the test program controlling unit 1803 included in the test program 1800 is made to run.

In step S2501, the test program controlling unit 1803 sets the variable i to 1. Moreover, in step S2502, the test program controlling unit 1803 executes the subsection i of the original program.

In step S2503, the test program controlling unit 1803 determines whether or not the execution of the original program in step S2502 has been normally terminated. If the execution of the original program in step S2502 is abnormally terminated (“NO” in step S2503), the test program controlling unit 1803 moves the process to step S2507, in which the execution of the original program is abnormally terminated.

If the execution of the original program in step S2502 is normally terminated (“YES” in step S2503), the test program controlling unit 1803 moves the process to step S2504. In this case, the test program controlling unit 1803 increments the variable i by 1 (step S2504). Then, the test program controlling unit 1803 moves the process to step S2505.

If the variable i is equal to or smaller than the number n of pieces of accompanying information stored in the subsection accompanying information 1802 in step S2505 (“NO” in step S2505), the test program controlling unit 1803 moves the process to step S2502. Alternatively, if the variable i is larger than the number n of pieces of accompanying information stored in the subsection accompanying information 1802 (“YES” in step S2505), the test program controlling unit 1803 moves the process to step S2506, in which the execution process of the test program 1800 is terminated.

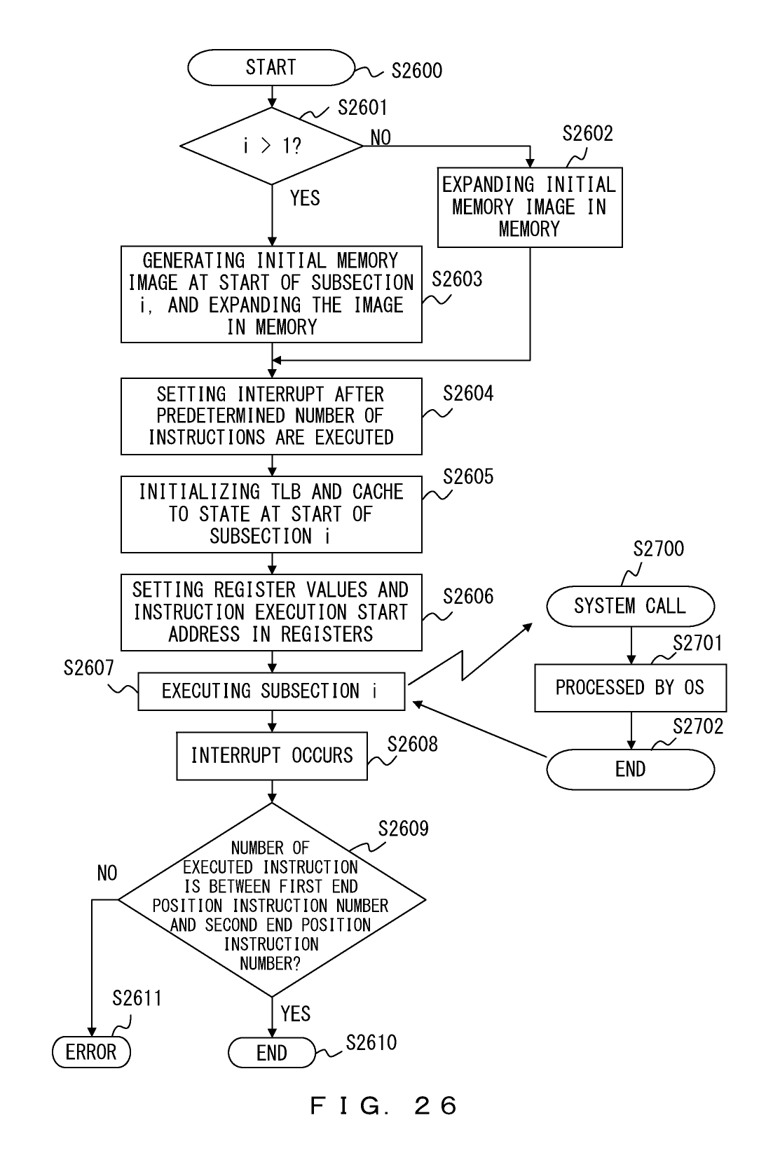

FIG. 26 is a flowchart illustrating an execution process when the test program 1800 is executed on the OS.

In step S2601, the test program controlling unit 1803 determines whether or not the variable i is larger than 1. If the variable i is 1 (“NO” in step S2601), the test program controlling unit 1803 moves the process to step S2602. In this case, the test program controlling unit 1803 expands an initial memory image 1801 in the original program reproduction space (step S2602).

If the variable i is larger than 1 (“YES” in step S2601), the test program controlling unit 1803 moves the process to step S2603. In this case, the test program controlling unit 1803 obtains memory initial image estimate information from the accompanying information of the subsection i. Then, the test program controlling unit 1803 generates an initial memory image a at the start position of the subsection i based on the obtained memory initial image estimate information, and expands the generated initial memory image a in the original program reproduction space (step S2603).

In step S2604, the test program controlling unit 1803 obtains the first end position instruction number from the executed instruction number information in the accompanying information of the subsection i. Then, the test program controlling unit 1803 makes settings for transferring a control from the original program to the test program controlling unit 1803 by causing an interrupt when instructions of the original program are executed by the first end position instruction number at and after the start position of the subsection i.

In step S2605, the test program controlling unit 1803 obtains TLB information and cache information from the initial value information of the accompanying information of the subsection i. Then, the test program controlling unit 1803 initializes the CPU 2400 to the state at the start position of the subsection i by changing contents of the TLB and the cache, which are included in the CPU 2400, according to the obtained TLB information and cache information.

In step S2606, the test program controlling unit 1803 obtains an instruction execution start address and register values from the initial value information of the accompanying information of the subsection i. Then, the test program controlling unit 1803 sets the obtained register values in the registers included in the CPU 2400. Moreover, the test program controlling unit 1803 sets the obtained instruction execution start address in the PC.

In step S2607, the CPU 2400 starts to execute the original program expanded in the original program reproduction space when the test program controlling unit 1803 instructs the CPU 2400 to run.

Here, if the original program issues a system call (step S2700), the OS provides a service requested by the original program to the original program (step S2701). When the requested service has been provided (step S2702), the process is moved to step S2607, in which the original program restarts to be executed.

In step S2608, an interrupt occurs when instructions of the original program are executed by the number of instructions, which is specified in step S2604, and a control is transferred from the original program to the test program controlling unit 1803.

If the number of executed instructions in step S2607 is within a range from the first end position instruction number to the second end position instruction number in step S2609, (“YES” in step S2609), the test program controlling unit 1803 moves the process to step S2610. Then, the test program controlling unit 1803 terminates the execution process of the test program. Alternatively, if the number of executed instructions in step S2607 is not within the range from the first end position instruction number to the second end position instruction number (“NO” in step S2609), the test program controlling unit 1803 moves the process to step S2611, in which the execution process of the test program 1800 is abnormally terminated.

FIG. 27 illustrates a configuration example of the test program generating apparatus 1100.

The test program generating apparatus 1100 is an information processing device including a memory 1101, a CPU 1102, an input device 1103, an output device 1104, a storage device 1105, a medium driving device 1106, and a network connecting device 1108 as needed.

The memory 1101 is a volatile memory, such as a RAM or the like, used to execute a program.

The CPU 1102 is a unit to execute a program that implements the test program generation process according to this embodiment in addition to execution of peripheral devices and various types of software. If need be, the CPU 1102 may include a mechanism for executing instructions one by one.

The input device 1103 is a unit, such as a keyboard, a mouse or the like, to which data is externally input. The output device 1104 is a device to output data and the like to a display device or the like.

The storage device 1105 is a unit to store a test program generation program for implementing the test program generation process according to this embodiment in addition to a program and data, which the test program generating apparatus 1100 needs to operate.

The medium driving device 1106 is a unit to output data of the memory 1101 or the storage device 1105 to a portable storage medium 1107 such as a floppy disk, an MO disk, a CD-R, a DVD-R or the like, or to read a program, data and the like from the portable storage medium 1107. The test program 1800 may be also stored onto the portable storage medium 1107.

The network connecting device 1108 is a unit to make a connection to a network 1109.

Among the devices used to generate and execute the above described test program 1800, the memory 1101 and the like may be cited as one example of the first storage unit and the second storing unit. Additionally, the original program and the like may be cited as one example of the first program.

Furthermore, the CPU 1102, the CPU emulator 1301 and the like may be cited as one example of the first arithmetic unit. The CPU emulator 2110, the CPU 2400 and the like may be cited as one example of the second arithmetic unit.

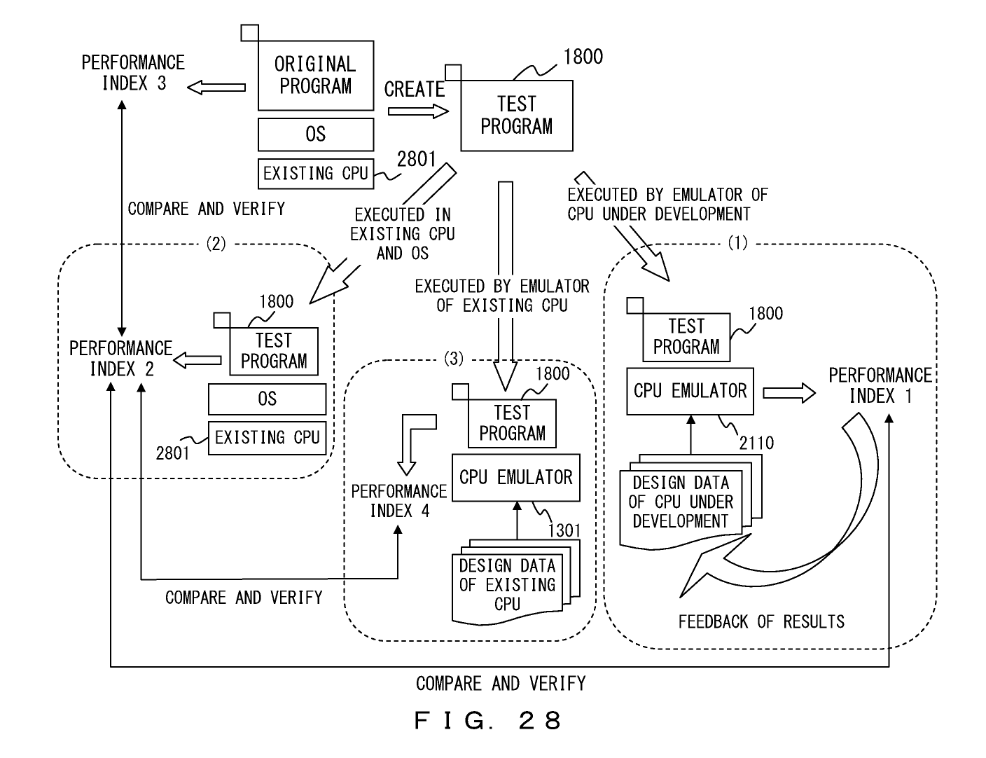

FIG. 28 is a schematic illustrating an outline of performance evaluation using the test program 1800 generated by the test program generating apparatus 1100. The following (1) to (3) respectively correspond to (1) to (3) of FIG. 28.

As described above, the test program generating apparatus 1100 takes execution histories by causing the CPU 1102 or the CPU emulator 1301 to execute the original program, and generates an initial memory image 1801 and subsection accompanying information 1802 based on the execution histories. Then, the test program generating apparatus 1100 generates the test program 1800 including the initial memory image 1801, the subsection accompanying information 1802, the test program controlling unit 1803, the monitor program 1804 and the monitor program initializing unit 1805.

(1) This test program 1800 may be executed in an environment without an OS because the monitor program initializing unit 1805 initializes the monitor program 1804 to a state executable in the privilege mode as illustrated in FIGS. 21 to 23. For example, the test program 1800 may be executed by the CPU emulator 2110 that emulates a CPU under development according to a design of the CPU.

Additionally, the test program 1800 may be executed on an OS without using the monitor program 1804 and the monitor program initializing unit 1805 as illustrated in FIGS. 24 to 26. For example, the test program 1800 may be executed in a state where an OS is installed in an information processing device including an existing CPU 2801.

Accordingly, the test program 1800 may cause the CPU emulator 2110 for emulating a CPU under development according to a design of the CPU and the existing CPU 2801 to execute the same process, namely, a subsection extracted from the original program.

Consequently, more accurate performance evaluation may be made by comparing execution results (performance index 1) of the test program 1800 by a CPU under development with execution results (performance index 2) of the test program 1800 by the existing CPU 2801. Moreover, the results of the performance evaluation are fed back to the design data of the CPU under development, whereby faults and the like may be improved before a prototype or the like is generated.

Additionally, the performance of the CPU under development may be more accurately predicted by comparing and analyzing the execution results (performance index 1) of the test program 1800 by the CPU under development and the execution results (performance index 2) of the test program 1800 by the existing CPU 2801.

(2) Furthermore, the execution results (performance index 2) obtained by executing the test program 1800 and execution results (performance index 3) obtained by executing the original program in a state where an OS is installed in an information processing device including the existing CPU 2801 may be compared and verified. As a result, it may be verified that subsections of the original program and the test program 1800 are programs that execute the same processes.

(3) Furthermore, the execution results (performance index 2) obtained by executing the test program 1800 in the state where the OS is installed in the information processing device including the existing CPU 2801, and execution results (performance index 4) obtained by causing the CPU emulator 1301 to execute the test program 1800 may be compared and verified. Note that the CPU emulator 1301 is an emulator for emulating the existing CPU 2801 according to a design of the CPU 2801.

As a result, it may be verified that the same process is executed when the test program 1800 is executed by a CPU without a support of an OS, and when the test program 1800 is executed on the OS.

The above described verifications in (2) and (3) may be made with the test program 1800, whereby a CPU under development may be ensured to execute the same process as an original program regardless of whether or not an OS is present. As a result, the performance evaluation in (1) may be more strictly performed.

The test program generating apparatus 1100 generates a test program 1800 by extracting processes in a plurality of subsections from an original program, whereby the test program 1800 may be generated by extracting, as subsections, only sections where a process desired to be used for the performance evaluation or the like.

In consequence, processes needed for the performance evaluation may be executed at one time, whereby efficiency of the performance evaluation may be improved. Moreover, the test program 1800 is generated by extracting only processes needed for the performance evaluation or the like. Therefore, hardware resources, such as a memory capacity and the like, needed to execute the test program 1800 may be reduced. For a similar reason, a very large amount of time generally needed to execute a program using a CPU emulator may be shortened.

The test program controlling unit 1803 reproduces an initial memory space at the start position of the subsection based on a memory space at the end position of the subsection i-1, and memory initial image estimate information of the accompanying information of the subsection i as represented by step S2603 of FIG. 26, and other steps. Accordingly, it may become unnecessary to provide the test program 1800 with a memory image used to reproduce an initial memory space at a start position of a subsection for each section. Consequently, the amount of memory capacity used to execute the test program 1800 may be reduced.

As described above, with the disclosed program generating apparatus, a test program for improving the accuracy of performance evaluation of an arithmetic device under development may be provided.

The process procedures represented with the flowcharts illustrated in FIGS. 12, 15A, 15B, 17A, 17B, 19, 20A, 20B, 22, 23, 25 and 26 are not intended to limit the order of processes. Accordingly, the order of the processes may be naturally changed if possible.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A program generating apparatus comprising:
a first storing unit configured to store data;
a first arithmetic unit configured to execute a first program stored in the first storing unit;
an execution history taking unit configured to store initial value information about a state of the first arithmetic unit at a start position of the subsection that is a partial section of the first program executed by the first arithmetic unit, and information about an instruction executed by the first arithmetic unit in the subsection and data referenced upon executing the instruction, as an execution history of a subsection when the first arithmetic unit executes the first program;
a memory image generating unit configured to generate a memory image that reproduces data used to execute the subsection by the first arithmetic unit within the first program stored in the first storing unit based on the execution history;
a subsection information generating unit configured to generate subsection information including the initial value information at the start position of the subsection; and
a second program generating unit configured to generate a second program including the memory image, the subsection information, a program controlling portion to store the memory image in a second storing unit used by a second arithmetic unit that executes an arbitrary program, to set the second arithmetic unit to the same state as the first arithmetic unit at the start position of the subsection according to the subsection information, and to cause the second arithmetic unit to execute the subsection of the first program, a monitor program including a function needed to execute the first program in the subsection among functions of an operating system, and a monitor program initializing portion configured to make settings for causing the monitor program to provide a service requested when the second arithmetic unit executes the first program after storing the monitor program in the second storing unit.

2. The program generating apparatus according to claim 1, wherein
when a plurality of subsections are provided, the subsection information generating unit generates estimate information that reproduces contents of the first storing unit at a start position of a second subsection next to the first subsection based on contents of the first storing unit at an end position of the first subsection, and makes second subsection information include the estimate information.

3. The program generating apparatus according to claim 2, wherein
the program controlling portion reproduces the same contents as contents stored in the first storing unit at the start position of the second subsection based on contents of the second storing unit at the end position of the first subsection and the estimate information included in the second subsection information, sets the second arithmetic unit to the same state as the first arithmetic unit at the start position of the second subsection according to the initial value information included in the second subsection information, and causes the second arithmetic unit to execute the second subsection of the first program.

4. The program generating apparatus according to claim 2, wherein
the subsection information generating unit generates the estimate information based on results of a comparison among contents, reproduced based on the execution history of the first subsection, of the first storing unit at a first end position within the first subsection, contents, reproduced based on the execution history of the first subsection, of the first storing unit at a second end position within the first subsection, and contents, reproduced based on an execution history of the second subsection, of the first storing unit at the start position of the second subsection.

5. The program generating apparatus according to claim 1, wherein
the initial value information includes contents of registers, a cache memory and a page translation table, which are included in the first arithmetic unit.

6. The program generating apparatus according to claim 1, wherein
the first arithmetic unit is a program executed on an operating system, and emulates an arbitrary arithmetic device.

7. The program generating apparatus according to claim 1, wherein
the first arithmetic unit is an arithmetic device having a function to execute instructions one by one, and executes the execution history taking unit every time the first arithmetic unit executes each of the instructions.

8. The program generating apparatus according to claim 7, wherein
the execution history taking unit stores, in an execution history, information about an instruction executed in a user mode, and data referenced when the instruction is executed.

9. The program generating apparatus according to claim 1, wherein
the program controlling portion causes the first arithmetic unit to terminate execution of the first program by causing an interrupt when the number of instructions, which is equivalent to the subsection, is executed.

10. A program generating method comprising:
storing initial value information about a state of a first arithmetic unit at a start position of the subsection that is a partial section of a first program executed by the first arithmetic unit, and information about an instruction executed by the first arithmetic unit in the subsection and data referenced upon executing the instruction, as an execution history of a subsection when the first arithmetic unit to execute the first program stored in the first storing unit;
generating a memory image that reproduces data used to execute the subsection by the first arithmetic unit within the first program stored in the first storing unit based on the execution history;
generating subsection information including the initial value information at the start position of the subsection; and
generating a second program including the memory image, the subsection information, a program controlling portion to store the memory image in a second storing unit used by a second arithmetic unit that executes an arbitrary program, to set the second arithmetic unit to the same state as the first arithmetic unit at the start position of the subsection according to the subsection information, and to cause the second arithmetic unit to execute the subsection of the first program, a monitor program including a function needed to execute the first program in the subsection among functions of an operating system, and a monitor program initializing portion configured to make settings for causing the monitor program to provide a service requested when the second arithmetic unit executes the first program after storing the monitor program in the second storing unit.

11. The program generating method according to claim 10, wherein
if a plurality of subsections are provided, estimate information that reproduces contents of the first storing unit at a start position of a second subsection next to the first subsection is generated based on contents of the first storing unit at an end position of the first subsection, and the estimate information is included in second subsection information.

12. The program generating method according to claim 11, wherein
if the plurality of subsections are provided, the same contents as contents stored by the first storing unit at the start position of the second subsection are reproduced based on contents of the second storing unit at the end position of the first subsection and the estimate information included in the second subsection information, the second arithmetic unit is set to the same state as the first arithmetic unit at the start position of the second subsection according to the initial value information included in the second subsection information, and the second arithmetic unit is caused to execute the second subsection of the first program.

13. The program generating method according to claim 11, wherein
the estimate information is generated based on results of a comparison among contents, reproduced based on the execution history of the first subsection, of the first storing unit at a first end position within the first subsection, contents, reproduced based on the execution history of the first subsection, of the first storing unit at a second end position within the first subsection, and contents, reproduced based on an execution history of the second subsection, of the first storing unit at the start position of the second subsection.

14. A non-transitory computer readable storage medium storing a program for causing an information processing device to execute a process, the process comprising:
storing initial value information about a state of a first arithmetic unit at a start position of the subsection that is a partial section of a first program executed by the first arithmetic unit, and information about an instruction executed by the first arithmetic unit in the subsection and data referenced upon executing the instruction, as an execution history of a subsection when the first arithmetic unit to execute the first program stored in the first storing unit;
generating a memory image that reproduces data used to execute the subsection by the first arithmetic unit within the first program stored in the first storing unit based on the execution history;
generating subsection information including the initial value information at the start position of the subsection; and
generating a second program including the memory image, the subsection information, a program controlling portion to store the memory image in a second storing unit used by a second arithmetic unit that executes an arbitrary program, to set the second arithmetic unit to the same state as the first arithmetic unit at the start position of the subsection according to the subsection information, and to cause the second arithmetic unit to execute the subsection of the first program, a monitor program including a function needed to execute the first program in the subsection among functions of an operating system, and a monitor program initializing portion configured to make settings for causing the monitor program to provide a service requested when the second arithmetic unit executes the first program after storing the monitor program in the second storing unit.

15. The storage medium according to claim 14, wherein
if a plurality of subsections are provided, estimate information that reproduces contents of the first storing unit at a start position of a second subsection next to the first subsection is generated based on contents of the first storing unit at an end position of the first subsection, and the estimate information is included in second subsection information.

16. The storage medium according to claim 15, wherein
if the plurality of subsections are provided, the same contents as contents stored by the first storing unit at the start position of the second subsection are reproduced based on contents of the second storing unit at the end position of the first subsection and the estimate information included in the second subsection information, the second arithmetic unit is set to the same state as the first arithmetic unit at the start position of the second subsection according to the initial value information included in the second subsection information, and the second arithmetic unit is caused to execute the second subsection of the first program.

17. The storage medium according to claim 15, wherein
the estimate information is generated based on results of a comparison among contents, reproduced based on the execution history of the first subsection, of the first storing unit at a first end position within the first subsection, contents, reproduced based on the execution history of the first subsection, of the first storing unit at the second end position within the first subsection, and contents, reproduced based on the execution history of the second subsection, of the first storing unit at the start position of the second subsection.
